(19) United States
(12) Patent Application Publication
(10) Pub. No.: US 2024/0073252 A1
(43) Pub. Date: Feb. 29, 2024

(54) SYSTEMS AND METHODS FOR EVENT-DRIVEN ORCHESTRATED WORKFLOWS WITH AUTOMATED ACTIONS IN RESPONSE TO SECURITY INCIDENTS

(71) Applicant: KnowBe4, Inc., Clearwater, FL (US)

(72) Inventors: Atish Kathpal, Bangalore (IN); Paras Nigam, Bangalore (IN); Vignesh Hari, Kerala (IN); Shilendra Soman, Kerala (IN); Abraham Brody, Thousand Oaks, CA (US); Rohan Puri, San Jose, CA (US)

(73) Assignee: KnowBe4, Inc., Clearwater, FL (US)

(21) Appl. No.: 18/240,167

(22) Filed: Aug. 30, 2023

Related U.S. Application Data
(60) Provisional application No. 63/402,596, filed on Aug. 31, 2022.

(51) Int. Cl. H04L 9/40

(52) U.S. Cl. CPC H04L 63/205

(57) ABSTRACT

Systems and methods are described for creating event-driven orchestrated workflows with automated actions in response to security incidents. In an example, a method is described that includes receiving an indication to create a workflow for automating a response to one or more users engaging in an action associated with a security incident and receiving a selection of the action associated with the security incident from a plurality of selectable actions. The selected action is configured into the workflow and configured to trigger execution of the workflow by a user of the one or more users taking the selected action.

### RELATED APPLICATION

This application claims the benefit of and priority to U.S. provisional application No. 63/402,596, filed on Aug. 31, 2022 and titled “SYSTEMS AND METHODS FOR EVENT-DRIVEN ORCHESTRATED WORKFLOWS WITH AUTOMATED ACTIONS IN RESPONSE TO SECURITY INCIDENTS”, which is incorporated in its entirety herein for all purposes.

### FIELD OF THE DISCLOSURE

This disclosure generally relates to security awareness management. In particular, the present disclosure relates to systems and methods for creating event-driven orchestrated workflows with automated actions in response to security incidents.

### BACKGROUND OF THE DISCLOSURE

Cybersecurity incidents cost companies millions of dollars each year in actual costs and can cause customers to lose trust in an organization. The incidents of cybersecurity attacks and the costs of mitigating the damage are increasing every year. Many organizations deploy multiple security and identity-based products to manage security posture. Examples of security and identity-based products include network security products, identity management products across business applications, web security products, endpoint security products, and collaboration tools like email, shared data drives, documentation, ticketing systems etc. These security and identity-based products detect, and report security incidents related to end users, such as users clicking on phishing links, users attempting to visit blocked uniform resource locators (URLs), the presence of weak user passwords, users browsing malicious websites, users downloading malware, etc.

### BRIEF SUMMARY OF THE DISCLOSURE

Systems and methods are provided for creating event-driven orchestrated workflows with automated actions in response to security incidents. In an example embodiment, a method is described that includes receiving an indication to create a workflow for automating a response to one or more users engaging in an action associated with a security incident and receiving a selection of the action associated with the security incident from a plurality of selectable actions. The selected action is configured into the workflow and configured to trigger execution of the workflow by a user of the one or more users taking the selected action. In some embodiments, the method includes receiving a selection of a response from a plurality of selectable responses for responding to the user of the one or more users taking the selected action associated with the security incident. The selected response is configured into the workflow and configured to be sent to one or more targets responsive to the selected action being performed. In some embodiments, the method includes establishing the workflow to be executed to send the selected response automatically responsive to performance of the selected action by the user of the one or more users being detected.

In some embodiments, the method further includes receiving a selection of one or more conditions from a plurality of selectable conditions for which to trigger one of execution of or progression through the workflow, the one or more selected conditions configured into the workflow.

In some embodiments, the method further includes receiving a selection of a schedule from a plurality of selectable schedules, the selected schedule configured into the workflow to cause the selected response to be sent by the workflow to the one or more targets according to the selected schedule.

In some embodiments, the method further includes receiving an input of the one or more targets to configure into the workflow, the one or more targets identifying one or more users or groups of users to which the workflow sends the selected response.

In some embodiments, the method further includes receiving a selection of one or more channels from a plurality of selectable channels, the selected one or more channels configured into the workflow to cause the workflow to send the selected response to the one or more targets via the selected one or more channels.

In some embodiments, the method further includes receiving administrator input to connect the selected action to the selected response to create the workflow.

In some embodiments, the method further includes receiving administrator input to arrange the selected action and the selected response on a canvas provided by the interface.

In some embodiments, the method further includes monitoring event data of the one or more users to detect the selected action.

In some embodiments, the method further includes receiving, responsive to monitoring, an indication that the selected action has been detected and responsive to the indication, triggering one of execution or progression of the workflow.

In some embodiments, the method further includes communicating, responsive to the selected action, the selected response to the one or more targets.

In another example embodiment, a system is described that includes one or more servers configured to receive, by an interface, an indication to create a workflow for automating a response to one or more users engaging in an action associated with a security incident. In some embodiments, the one or more servers are configured to receive, by the interface, a selection of the action associated with the security incident from a plurality of selectable actions, the selected action configured into the workflow and configured to trigger execution of the workflow by a user of the one or more users taking the selected action. In some embodiments, the one or more servers are configured to receive, by the interface, a selection of a response from a plurality of selectable responses for responding to the user of the one or more users taking the selected action associated with the security incident, the selected response configured into the workflow and configured to be sent to one or more targets responsive to the selected action being performed. Further, in some embodiments, the one or more servers are configured to establish the workflow to be executed to send the selected response automatically responsive to performance of the selected action by the user of the one or more users being detected.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a could computing environment comprising client device in communication with cloud service providers;

FIGS. 1C and 1D are block diagrams depicting embodiments of computing devices useful in connection with the methods and systems described herein;

FIG. 2 depicts an implementation of some of a server architecture of a system for creating event-driven orchestrated workflows with automated actions in response to security incidents, according to one or more embodiments;

FIG. 3 depicts a menu for creation of security awareness orchestration workflows, according to some embodiments;

FIG. 4 illustrates an interface canvas for creating new workflows, according to some embodiments;

FIG. 5 illustrates an interface canvas describing an action element of a workflow creation toolbar, according to some embodiments;

FIG. 6 illustrates an interface canvas where a system administrator has selected a “malware detected” subelement of an action element of a workflow creation toolbar, according to some embodiments;

FIG. 7 illustrates an interface canvas showing a drop-down menu for further configuration of a “malware detected” subelement, according to some embodiments;

FIG. 8 illustrates an interface canvas describing a condition element of a workflow creation toolbar, according to some embodiments

FIG. 9 illustrates an interface canvas describing a schedule element of a workflow creation toolbar, according to some embodiments.

FIG. 10 illustrates an interface canvas describing a target element of a workflow creation toolbar, according to some embodiments;

FIG. 11 illustrates an interface canvas describing a response element of a workflow creation toolbar, according to some embodiments;

FIG. 12 illustrates an interface canvas describing a channel element of a workflow creation toolbar, according to some embodiments;

FIG. 13 illustrates an example of a workflow within a workflow designer workspace, according to some embodiments;

FIG. 14 illustrates an example for further configuration of a channel subelement within a workflow designer workspace, according to some embodiments;

FIG. 15 illustrates an example for further configuration of a target subelement within a workflow designer workspace, according to some embodiments;

FIG. 16 illustrates an example of multiple workflows within a single workflow designer workspace, according to some embodiments;

FIG. 17 depicts an example of system architecture components and their relationships, according to some embodiments;

FIG. 18A, FIG. 18B, and FIG. 18C depict examples of information exchange between system architecture components, according to some embodiments;

FIG. 19 depicts a flowchart for establishing a workflow to be executed to send a response automatically responsive to a performance of an action by a user of one or more users being detected, according to some embodiments; and

FIG. 20A and FIG. 20B depict a flowchart for establishing a workflow to be executed to send a response automatically responsive to a performance of an action by a user and for communicating selected response to one or more targets, according to some embodiments.

### DETAILED DESCRIPTION

For purposes of reading the description of the various embodiments below, the following descriptions of the sections of the specifications and their respective contents may be helpful:

Section A describes a network environment and computing environment which may be useful for practicing embodiments described herein.

Section B describes embodiments of systems and methods for creating event-driven orchestrated workflows with automated actions in response to security incidents.

### A. Computing and Network Environment

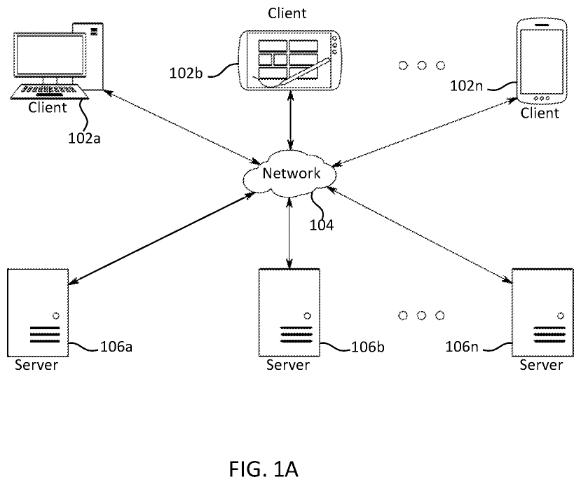

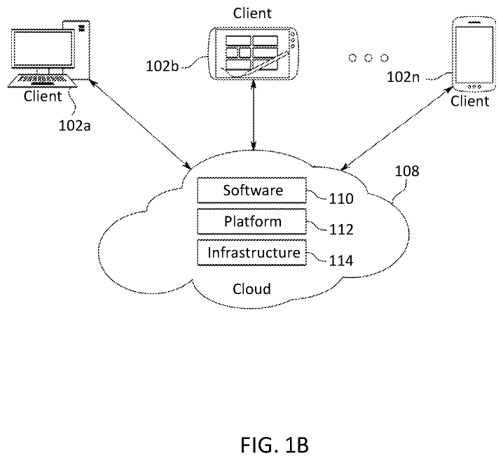

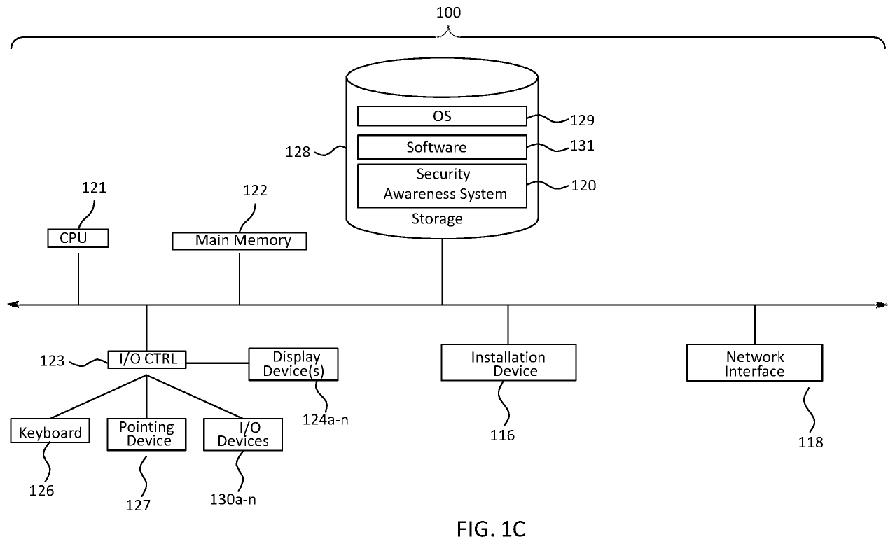

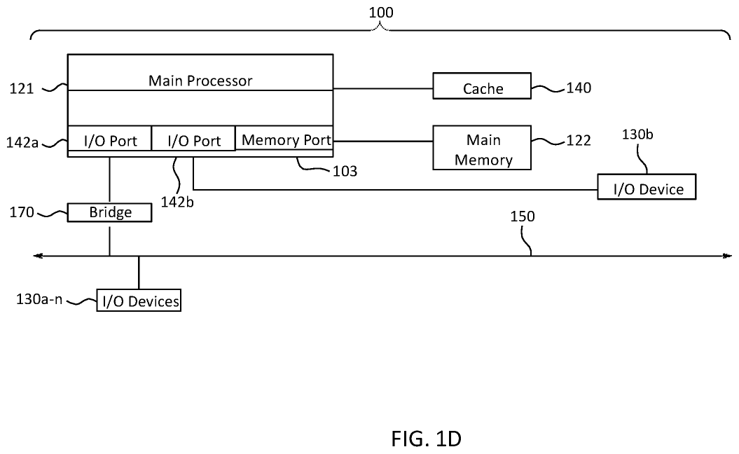

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In a brief overview, the network environment includes one or more clients 102a-102n (also generally referred to as local machines(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node(s) 106, machine(s) 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ may be a public network. In still another of these embodiments, networks 104 and 104′ may both be private networks.

The network 104 may be connected via wired or wireless links. Wired links may include Digital Subscriber Line (DSL), coaxial cable lines, or optical fiber lines. Wireless links may include Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, NFC, SigFox, LoRa, Random Phase Multiple Access (RPMA), Weightless-N/P/W, an infrared channel, or a satellite band. The wireless links may also include any cellular network standards to communicate among mobile devices, including standards that qualify as 1G, 2G, 3G, 4G, or 5G. The network standards may qualify as one or more generations of mobile telecommunication standards by fulfilling a specification or standards such as the specifications maintained by the International Telecommunication Union. The 3G standards, for example, may correspond to the International Mobile Telecommuniations-2000 (IMT-2000) specification, and the 4G standards may correspond to the International Mobile Telecommunication Advanced (IMT-Advanced) specification. Examples of cellular network standards include AMPS, GSM, GPRS, UNITS, CDMA2000, CDMA-1×RTT, CDMA-EVDO, LTE, LTE-Advanced, LTE-M1, and Narrowband IoT (NB-IoT). Wireless standards may use various channel access methods, e.g., FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network may vary widely and the network 104 can be a body area network (BAN), a personal area network (PAN), a local-area network (LAN), e.g., Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv4 and IPv6), or the link layer. The network 104 may be a type of broadcast network, a telecommunications network, a data communication network, or a computer network.

In some embodiments, the system may include multiple, logically grouped servers 106. In one of these embodiments, the logical group of servers may be referred to as a server farm or a machine farm. In another of these embodiments, the servers 106 may be geographically dispersed. In other embodiments, a machine farm may be administered as a single entity. In still other embodiments, the machine farm includes a plurality of machine farms. The servers 106 within each machine farm can be heterogeneous—one or more of the servers 106 or machines 106 can operate according to one type of operating system platform (e.g., Windows, manufactured by Microsoft Corp. of Redmond, Washington), while one or more of the other servers 106 can operate according to another type of operating system platform (e.g., Unix, Linux, or Mac OSX).

In one embodiment, servers 106 in the machine farm may be stored in high-density rack systems, along with associated storage systems, and located in an enterprise data center. In this embodiment, consolidating the servers 106 in this way may improve system manageability, data security, the physical security of the system, and system performance by locating servers 106 and high-performance storage systems on localized high-performance networks. Centralizing the servers 106 and storage systems and coupling them with advanced system management tools allows more efficient use of server resources.

The servers 106 of each machine farm do not need to be physically proximate to another server 106 in the same machine farm. Thus, the group of servers 106 logically grouped as a machine farm may be interconnected using a wide-area network (WAN) connection or a metropolitan-area network (MAN) connection. For example, a machine farm may include servers 106 physically located in different continents or different regions of a continent, country, state, city, campus, or room. Data transmission speeds between servers 106 in the machine farm can be increased if the servers 106 are connected using a local-area network (LAN) connection or some form of direct connection. Additionally, a heterogeneous machine farm may include one or more servers 106 operating according to a type of operating system, while one or more other servers execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alta, California; the Xen hypervisor, an open-source product whose development is overseen by Citrix Systems, Inc. of Fort Lauderdale, Florida; the HYPER-V hypervisors provided by Microsoft, or others. Hosted hypervisors may run within an operating system on a second software level. Examples of hosted hypervisors may include VMWare Workstation and VirtualBox, manufactured by Oracle Corporation of Redwood City, California.

Management of the machine farm may be de-centralized. For example, one or more servers 106 may comprise components, subsystems, and modules to support one or more management services for the machine farm. In one of these embodiments, one or more servers 106 provide functionality for management of dynamic data, including techniques for handling failover, data replication, and increasing the robustness of the machine farm. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, a plurality of servers 106 may be in the path between any two communicating servers 106.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or zero client may depend on the connection to the cloud 108 or server 106 to provide functionality. A zero client may depend on the cloud 108 or other networks 104 or servers 106 to retrieve operating system data for the client device 102. The cloud 108 may include back-end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 109 may include both the private and public networks 104 and servers 106.

The cloud 108 may also include a cloud-based delivery, e.g., Software as a Service (SaaS) 110, Platform as a Service (PaaS) 112, and Infrastructure as a Service (IaaS) 114. IaaS may refer to a user renting the user of infrastructure resources that are needed during a specified time period. IaaS provides may offer storage, networking, servers, or virtualization resources from large pools, allowing the users to quickly scale up by accessing more resources as needed. Examples of IaaS include Amazon Web Services (AWS) provided by Amazon, Inc. of Seattle, Washington, Rackspace Cloud provided by Rackspace Inc. of San Antonio, Texas, Google Compute Engine provided by Google Inc. of Mountain View, California, or RightScale provided by RightScale, Inc. of Santa Barbara, California. PaaS providers may offer functionality provided by IaaS, including, e.g., storage, networking, servers, or virtualization, as well as additional resources, e.g., the operating system, middleware, or runtime resources. Examples of PaaS include Windows Azure provided by Microsoft Corporation of Redmond, Washington, Google App Engine provided by Google Inc., and Heroku provided by Heroku, Inc. of San Francisco California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include Google Apps provided by Google Inc., Salesforce provided by Salesforce.com Inc. of San Francisco, California, or Office365 provided by Microsoft Corporation. Examples of SaaS may also include storage providers, e.g., Dropbox provided by Dropbox Inc. of San Francisco, California, Microsoft OneDrive provided by Microsoft Corporation, Google Drive provided by Google Inc., or Apple iCloud provided by Apple Inc. of Cupertino, California.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP,)(NIL, or other protocols. Clients 102 may access SaaS resources through the use of web-based user interfaces, provided by a web browser (e.g., Google Chrome, Microsoft Internet Explorer, or Mozilla Firefox provided by Mozilla Foundation of Mountain View, California). Clients 102 may also access SaaS resources through smartphone or tablet applications, including e.g., Salesforce Sales Cloud, or Google Drive App. Clients 102 may also access SaaS resources through the client operating system, including e.g., Windows file system for Dropbox.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g., a computer, network device or appliance capable of communicating on any type and form of network and performing the operations described herein.

FIG. 1C and FIG. 1D depict block diagrams of a computing device 100 useful for practicing an embodiment of the client 102 or a server 106. As shown in FIG. 1C and FIG. 1D, each computing device 100 includes a central processing unit 121, and a main memory unit 122. As shown in FIG. 1C, a computing device 100 may include a storage device 128, an installation device 116, a network interface 118, and I/O controller 123, display devices 124a-124n, a keyboard 126 and a pointing device 127, e.g., a mouse. The storage device 128 may include, without limitation, an operating system 129, software 131, and software of a security awareness system 120. As shown in FIG. 1D, each computing device 100 may also include additional optional elements, e.g., a memory port 103, a bridge 170, one or more input/output devices 130a-130n (generally referred to using reference numeral 130), and a cache memory 140 in communication with the central processing unit 121.

The central processing unit 121 is any logic circuitry that responds to, and processes instructions fetched from the main memory unit 122. In many embodiments, the central processing unit 121 is provided by a microprocessor unit, e.g.: those manufactured by Intel Corporation of Mountain View, California; those manufactured by Motorola Corporation of Schaumburg, Illinois; the ARM processor and TEGRA system on a chip (SoC) manufactured by Nvidia of Santa Clara, California; the POWER7 processor, those manufactured by International Business Machines of White Plains, New York; or those manufactured by Advanced Micro Devices of Sunnyvale, California. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic Random-Access Memory (DRAM) or any variants, including static Random-Access Memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile, e.g., non-volatile read access memory (NVRAM), flash memory non-volatile static RAM (nvSRAM), Ferroelectric RAM (FeRAM), Magnetoresistive RAM (MRAM), Phase-change RAM (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above-described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, a PCI-Express bus, or a NuBus. For embodiments in which the I/O device is a video display 124, the processor 121 may use an Advanced Graphic Port (AGP) to communicate with the display 124 or the I/O controller 123 for the display 124. FIG. 1D depicts and embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex cameras (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple iPhone. Some devices 130a-130n allow gesture recognition inputs through combining some of the inputs and outputs. Some devices 130a-130n provide for facial recognition which may be utilized as an input for different purposes including authentication and other commands. Some devices 130a-130n provide for voice recognition and inputs, including, e.g., Microsoft KINECT, SIRI for iPhone by Apple, Google Now or Google Voice Search, and Alexa by Amazon.

Additional devices 130a-130n have both input and output capabilities, including, e.g., haptic feedback devices, touchscreen displays, or multi-touch displays. Touchscreen displays, multi-touch displays, touchpads, touch mice, or other touch sensing devices may use different technologies to sense touch, including, e.g., capacitive, surface capacitive, projected capacitive touch (PCT), in cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augmented reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, a I/O device 130 may be a bridge between the system bus 150 and an external communication bus, e.g., a USB bus, a SCSI bus, a FireWire bus, an Ethernet bus, a Gigabit Ethernet bus, a Fiber Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g., stereoscopy, polarization filters, active shutters, or auto stereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect, or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments, software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g., one or more hard disk drives or redundant arrays of independent disks) for storing an operating system or other related software, and for storing application software programs such as any program related to the software of a security awareness system 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage devices 128 may be non-volatile, mutable, or read-only. Some storage devices 128 may be internal and connect to the computing device 100 via a bus 150. Some storage devices 128 may be external and connect to the computing device 100 via a I/O device 130 that provides an external bus. Some storage devices 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage devices 128 may also be used as an installation device 116 and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, InfiniBand), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.1 1a/b/g/n/ac CDMA, GSM, WiMAX, and direct asynchronous connections). In one embodiment, the computing device 100 communicates with other computing devices 100′ via any type and/or form of gateway or tunneling protocol e.g., Secure Socket Layer (SSL) or Transport Layer Security (TLS), or the Citrix Gateway Protocol manufactured by Citrix Systems, Inc. The network interface 118 may comprise a built-in network adapter, network interface card, PCMCIA network card, EXPRESSCARD network card, card bus network adapter, wireless network adapter, USB network adapter, modem, or any other device suitable for interfacing the computing device 100 to any type of network capable of communication and performing the operations described herein.

A computing device 100 of the sort depicted in FIG. 1B and FIG. 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, WINDOWS 8, and WINDOW 10, all of which are manufactured by Microsoft Corporation of Redmond, Washington; MAC OS and iOS, manufactured by Apple, Inc.; and Linux, a freely available operating system, e.g., Linux Mint distribution (“distro”) or Ubuntu, distributed by Canonical Ltd. of London, United Kingdom; or Unix or other Unix-like derivative operating systems; and Android, designed by Google Inc., among others. Some operating systems, including, e.g., the CHROME OS by Google Inc., may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, or a NINTENDO DS, NINTENDO 3DS, NINTENDO WII, or a NINTENDO WII U device manufactured by Nintendo Co., Ltd., of Kyoto, Japan, or an XBOX 360 device manufactured by Microsoft Corporation.

In some embodiments, the computing device 100 is a digital audio player such as the Apple IPOD, IPOD Touch, and IPOD NANO lines of devices, manufactured by Apple Computer of Cupertino, California. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g., the IPAD line of devices by Apple; GALAXY TAB family of devices by Samsung; or KINDLE FIRE, by Amazon.com, Inc. of Seattle, Washington. In other embodiments, the computing device 100 is an eBook reader, e.g., the KINDLE family of devices by Amazon.com, or NOOK family of devices by Barnes & Noble, Inc. of New York City, New York.

In some embodiments, the communications device 102 includes a combination of devices, e.g., a smartphone combined with a digital audio player or portable media player. For example, one of these embodiments is a smartphone, e.g., the iPhone family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g., a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU, and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Systems and Methods for Event-Driven Orchestrated Workflows with Automated Actions in Response to Security Incidents

The following describes systems and methods for creating event-driven orchestrated workflows with automated actions in response to security incidents.

Hackers may exploit users of an organization to gain access to assets of the organization. In response, the organization may provide security training to their users to minimize the chance that the users interact with cybersecurity attacks or are involved in other security incidents. In certain scenarios, generic security training may not be effective in educating users in security awareness best practices, as it is often administered to users without context and in a poorly timed manner. Furthermore, as security threats become increasingly sophisticated and organizations mature and grow, generalized training templates may not reflect the most recent advancements in an organization's security policies or systems.

Systems for delivering effective security awareness training to users of an organization may rely on multiple tools and contextual parameters, each of which may need to be adjusted to reflect different gaps in security awareness of each user. Further, manual creation and personalization of security awareness training templates may be tedious, and the training provided to the users may be inadequate for addressing an organization's security awareness needs. With the human element becoming increasingly critical to the security posture of an organization, the traditional approaches of ‘one size fits all’ training responses for security awareness user failures are inadequate because these traditional approaches do not adapt in real time and are not tailored to user actions or to conditions and schedules of the actions occurring. Similarly, responses and the channels that the responses are sent through may depend on actions, conditions, and schedule of the actions, as well as target for the responses. Static workflows based on multiple dependent conditions are difficult to envision and design. Also, currently there is no easy way to design workflows which takes the history of the workflow or the history of other workflows as an input. Therefore, systems and methods for creating event-driven orchestrated security awareness workflows that automatically perform actions in response to different security incidents and user attributes are required.

The present disclosure describes systems and methods for creating and customizing security awareness orchestration workflows that facilitate, in response to one or more users of an organization engaging in an action associated with a security threat, delivery of one or more remedial responses to one or more targets.

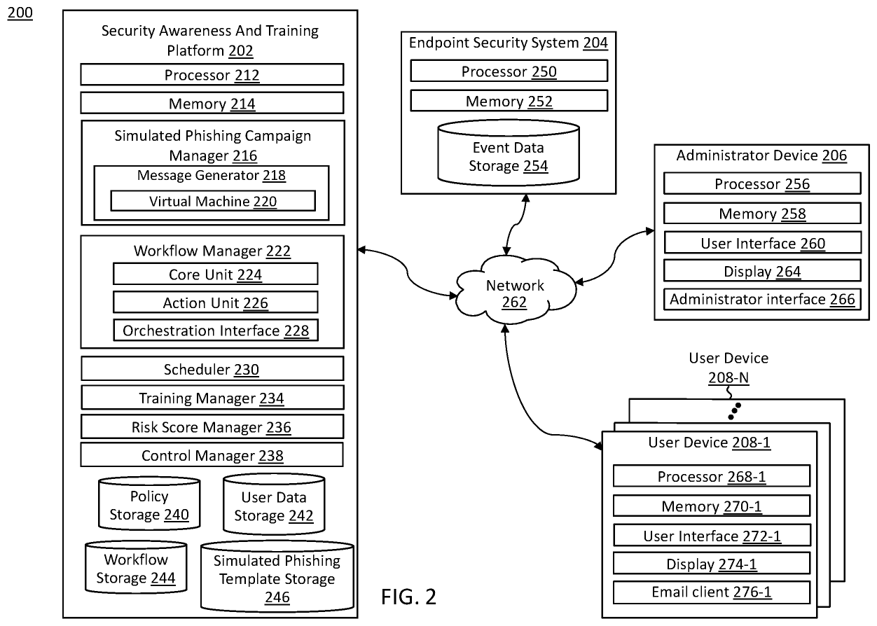

Referring to FIG. 2, in a general overview, FIG. 2 depicts some of the server architecture of an implementation of system 200 for creating event-driven orchestrated workflows with automated actions in response to security incidents, according to some embodiments. System 200 may include security awareness and training platform 202, endpoint security system 204, administrator device 206, user device(s) 208-(1-N), and network 262 enabling communication between the system components for information exchange. Network 262 may be an example or instance of network 104, details of which are provided with reference to FIG. 1A and its accompanying description.

According to some embodiments, security awareness and training platform 202 and endpoint security system 204 may be implemented in a variety of computing systems, such as a mainframe computer, a server, a network server, a laptop computer, a desktop computer, a notebook, a workstation, and the like. In an implementation, security awareness and training platform 202 and endpoint security system 204 may be implemented in a server, such as server 106 shown in FIG. 1A. In some implementations, security awareness and training platform 202 and endpoint security system 204 may be implemented by a device, such as computing device 100 shown in FIG. 1C and FIG. 1D. In some embodiments, each of security awareness and training platform 202 and endpoint security system 204 may be implemented as a part of a cluster of servers. In some embodiments, each of security awareness and training platform 202 and endpoint security system 204 may be implemented across a plurality of servers, thereby, tasks performed by each of security awareness and training platform 202 and endpoint security system 204 and may be performed by the plurality of servers. These tasks may be allocated among the cluster of servers by an application, a service, a daemon, a routine, or other executable logic for task allocation. The term “application” as used herein may refer to one or more applications, services, routines, or other executable logic or instructions. Each of security awareness and training platform 202 and each of security awareness and training platform 202 and endpoint security system 204 may comprise a program, service, task, script, library, application, or any type and form of executable instructions or code executable on one or more processors. Each of security awareness and training platform 202 and endpoint security system 204 may be combined into one or more modules, applications, programs, services, tasks, scripts, libraries, applications, or executable code.

In one or more embodiments, security awareness and training platform 202 may be a system that manages items relating to cybersecurity awareness for an organization. The organization may be an entity that is subscribed to or makes use of services provided by security awareness and training platform 202. In examples, the organization may be expanded to include all users within the organization, vendors to the organization, or partners of the organization. According to an implementation, security awareness and training platform 202 may be deployed by the organization to monitor and educate users thereby reducing cybersecurity threats to the organization. In an implementation, security awareness and training platform 202 may educate users within the organization by executing orchestrated workflows that trigger the delivery of responses to target users (referred to generally as ‘target’ or ‘targets’) over one or more channels, in response to one or more users engaging in an action that is associated with a security threat. In an example, a target may include a user of the organization that may be tested and trained by security awareness and training platform 202. In examples, a user of the organization that may engage in an action that is associated with a security threat may include an individual that can or does receive electronic messages. For example, the user may be an employee of the organization, a partner of the organization, a member of a group, an individual who acts in any capacity with security awareness and training platform 202 (such as a system administrator or a security administrator), or anyone associated with the organization. The system administrator may be an individual or team responsible for managing organizational cybersecurity aspects on behalf of an organization. The system administrator may oversee and manage security awareness and training platform 202 to ensure cybersecurity awareness training goals of the organization are met. For example, the system administrator may oversee Information Technology (IT) systems of the organization for configuration of system personal information use, managing simulated phishing campaigns, identification, and classification of threats within reported emails, creation of orchestrated security workflows, and any other element within security awareness and training platform 202. Examples of a system administrator include an IT department, a security administrator, a security team, a manager, or an Incident Response (IR) team. In some implementations, security awareness and training platform 202 may be owned or managed or otherwise associated with an organization or any entity authorized thereof. A simulated phishing attack is a technique of testing a user to see whether the user is likely to recognize a true malicious phishing attack and act appropriately upon receiving the malicious phishing attack. The simulated phishing attack may include links, attachments, macros, or any other simulated phishing threat (also referred to as an exploit) that resembles a real phishing threat. In response to user interaction with the simulated phishing attack, for example, if the user clicks on a link (i.e., a simulated phishing link), the user may be provided with security awareness training. In an example, security awareness and training platform 202 may be a Computer Based Security Awareness Training (CBSAT) system that performs security services such as performing simulated phishing attacks on a user or a set of users of the organization as a part of security awareness training.

According to some embodiments, security awareness and training platform 202 may include processor 212 and memory 214. For example, processor 212 and memory 214 of security awareness and training platform 202 may be CPU 121 and main memory 122, respectively as shown in FIG. 1C and FIG. 1D. Further, security awareness and training platform 202 may include simulated phishing campaign manager 216. Simulated phishing campaign manager 216 may include various functionalities that may be associated with cybersecurity awareness training. In an implementation, simulated phishing campaign manager 216 may be an application or a program that manages various aspects of a simulated phishing attack, for example, tailoring and/or executing a simulated phishing attack. A simulated phishing attack may test the readiness of a user to handle phishing attacks such that malicious actions are prevented. For instance, simulated phishing campaign manager 216 may monitor and control timing of various aspects of a simulated phishing attack including processing requests for access to attack results and performing other tasks related to the management of a simulated phishing attack.

In some embodiments, simulated phishing campaign manager 216 may include message generator 218 having virtual machine 220. Message generator 218 may be an application, service, daemon, routine, or other executable logic for generating messages. The messages generated by message generator 218 may be of any appropriate format. For example, the messages may be email messages, text messages, short message service (SMS) messages, instant messaging (IM) messages used by messaging applications such as, e.g., WhatsApp™, or any other type of message. The format or manner in which a message is generated by message generator 218 or simulated phishing campaign manager 216 when executing a workflow may be referred to as a ‘channel’. The channel utilized for delivering a message to a target may be configured as part of a workflow, for example using workflow manager 222. In examples, message type to be used in a particular simulated phishing communication may be determined by, for example, simulated phishing campaign manager 216. Message generator 218 generates the messages in any appropriate manner, e.g., by running an instance of an application that generates the desired message type, such as running, e.g., a Gmail® application, Microsoft Outlook™, WhatsApp™, a text messaging application, or any other appropriate application. Message generator 218 may generate messages by running a messaging application on virtual machine 220 or in any other appropriate environment. Message generator 218 generates the messages to be in a format consistent with specific messaging platforms, for example, Outlook 365™, Outlook Web Access (OWA), Webmail™, iOS®, Gmail®, and such formats.

In an implementation, message generator 218 may be configured to generate simulated phishing communications using a simulated phishing template. A simulated phishing template is a framework used to create simulated phishing communications. In some examples, the simulated phishing template may specify the layout and content of the simulated phishing communications. In some examples, the simulated phishing template may be designed according to theme or subject matter. The simulated phishing template may be configurable by a system administrator or by workflow manager 222. For example, the system administrator or workflow manager 222 may be able to add dynamic content to the simulated phishing template, such as a field that will populate with the target's name and email address when message generator 218 prepares simulated phishing communications based on the simulated phishing template for sending to a target. In an example, the system administrator may be able to select one or more exploits to include in the simulated phishing template, for example, one or more simulated malicious URLs, one or more simulated macros, and/or one or more simulated attachments, for example as specified by a ‘response’ in an orchestrated security workflow. An exploit is an interactable phishing tool in simulated phishing messages based on simulated phishing templates that can be clicked on or otherwise interacted with by a target. A simulated phishing template customized by the system administrator or by workflow manager 222 may be stored in simulated phishing template storage 246 or in workflow storage 244 (explained later), such that the simulated phishing template can be used for multiple different targets in the organization over a period of time or for different campaigns or for different security orchestration workflows. In some examples, a system administrator or workflow manager 222 may select a simulated phishing template from a pool of available simulated phishing templates stored in simulated phishing template storage and may send such a “stock” template to a target unchanged.

In some embodiments, security awareness and training platform 202 may include workflow manager 222. Workflow manager 222 may include various functionalities that may be associated with creation of security orchestration workflows (also referred to as ‘workflows’ or a ‘workflow’). A workflow may refer to a series of activities that execute in a particular order to achieve a process or a task. In an example, a workflow may be created to deliver responses to targets based on insecure activities of users. In an implementation, workflow manager 222 may be an application or a program that manages various aspects of security awareness orchestration workflows or that creates various aspects of security awareness orchestration workflows. A security awareness orchestration workflow may be a workflow designed to improve the security posture of an organization by way of delivering responses to one or more targets of the organization following one or more users' engagement in an action associated with a security risk.

In some embodiments, workflow manager 222 may include core unit 224 and action unit 226. In an implementation, core unit 224 and action unit 226, amongst other units, may include routines, programs, objects, components, data structures, etc., which may perform particular tasks or implement particular abstract data types. In examples, core unit 224 and action unit 226 may also be implemented as signal processor(s), state machine(s), logic circuitries, and/or any other device or component that manipulate signals based on operational instructions.

In some embodiments, core unit 224 and action unit 226 may be implemented in hardware, instructions executed by a processing module, or by a combination thereof. In examples, the processing module may be main processor 121, as shown in FIG. 1D. The processing module may comprise a computer, a processor, a state machine, a logic array, or any other suitable devices capable of processing instructions. The processing module may be a general-purpose processor which executes instructions to cause the general-purpose processor to perform the required tasks or, the processing module may be dedicated to performing the required functions. In some embodiments, core unit 224 and action unit 226 may be machine-readable instructions which, when executed by a processor/processing module, perform the intended functionalities of core unit 224 and action unit 226. The machine-readable instructions may be stored on an electronic memory device, hard disk, optical disk, or other machine-readable storage medium or non-transitory medium. In an implementation, the machine-readable instructions may also be downloaded to the storage medium via a network connection.

According to an implementation, workflow manager 222 may further include orchestration interface 228, such as a keyboard, a mouse, a touch screen, a haptic sensor, a voice-based input unit, or any other appropriate user interface. It shall be appreciated that such components may correspond to similar components of computing device 100 in FIG. 1C and FIG. 1D, such as keyboard 126, pointing device 127, I/O devices 130a-n and display devices 124a-n.

Security awareness and training platform 202 may include scheduler 230. In an implementation, scheduler 230 may be responsible for scheduling tasks to be performed or executed by security awareness and training platform 202. In an example, scheduler 230 may be responsible for scheduling one or more responses to be delivered to one or more targets according to a security orchestration workflow. In an example, scheduler 230 may select which aspect of a security orchestration workflow is to be executed next. In an implementation, scheduler 230 may include a scheduling algorithm for carrying out the scheduling activities as required by one or more security orchestration workflows or one or more simulated phishing campaigns.

In some embodiments, security awareness and training platform 202 may include training manager 234, risk score manger 236, and control manager 238. In an implementation, training manager 234 may include various functionalities that may be associated with providing security awareness training to users of the organization. In an example, training material may be provided or presented to the users as a part of training. In one example, training manager 234 provides or presents the training material when the user interacts with a simulated phishing message. In some examples, training manager 234 provides or presents training material during usual training sessions. The training material may include material to educate users of the risk of interacting with suspicious messages (communications) and train users on precautions in dealing with unknown, untrusted, and suspicious messages.

In an implementation, training manager 234 may provide training to the users via landing pages. In an example, a landing page may be a web page element which enables provisioning of training materials. In some examples, the landing page may be a pop-up message. A pop-up message shall be understood to refer to the appearance of graphical or textual content on a display. In examples, the training material or the learning material may be presented on the display as part of, or bounded within, a “window” or a user interface element or a dialogue box. Whilst other known examples and implementations of training materials are contemplated herein.

In an implementation, risk score manager 236 may be an application or a program that manages risk scores of users of an organization. In examples, risk score manager 236 may be configured to determine, assign, or update risk scores for users. A risk score of a user quantifies a cybersecurity risk that the user poses to an organization. In other words, a risk score of a user may be a representation of vulnerability of the user to a malicious attack or a likelihood that a user may engage in an action associated with a security risk. In one example, a user with a higher risk score may present a greater risk to the organization and a user with a lower risk score may present a lower risk to the organization. In an implementation, risk score manager 236 may update a risk score of a user based on user's interaction with one or more simulated phishing communications.

According to an implementation, control manager 238 may be an application or a program that manages controlling of security aspects of the organization. In some implementations, control manager 238 may be configured to change access privileges for users who have violated policies or rules of the organization, or for users who have demonstrated maturity in handling simulated phishing messages. In an example, access to storages or document editing rights may be limited for users who have violated policies or rules of the organization. In some examples, access to storages or document editing rights may be provided to users who have demonstrated maturity in handling simulated phishing messages. In an implementation, control manager 238 may limit users' access to some IT functions or parts of the organization, for example if the failure rate of users on simulated phishing campaigns is higher than the expected failure rate or if the users have a high risk score. In some implementations, control manager 238 may add one or more users (targets) to restricted groups in response to their interaction with simulated phishing communications. In some implementations, control manager 238 may update organization policies in response to one or more users engaging in an action associated with a security incident. For example, control manager 238 may update the organizational policies to increase a requirement to provide access privileges, access to IT functions, etc., based on the risk scores.

In some embodiments, security awareness and training platform 202 may include policy storage 240, user data storage 242, workflow storage 244, and simulated phishing template storage 246. In an implementation, policy storage 240 may store information related to policies of an organization. Examples of policies include, but are not limited to, data retention policy, network security policy, password creation and management policy, remote access policy, acceptable use policy, and incident response policy.

In an implementation, user data storage 242 may store metadata or other information related to actions associated with security threats or involvement in one or more security orchestration workflows (e.g., as a user that engages in an action associated with a security threat or as a target or a response of the workflow) relating to users of an organization. In an example, user data storage 242 may store personal information of the users and user attributes. In some implementations, user data storage 242 may also store information associated with actions performed by users with respect to simulated phishing campaigns, training campaigns, remedial trainings, and other such campaigns and trainings. In some implementations, user data storage 242 may store risk scores of users of an organization. A risk score of a user quantifies a cybersecurity risk that the user poses to an organization. In other words, a risk score of a user may be a representation of vulnerability of the user to a malicious attack or the likelihood that a user may engage in an action associated with a security risk. In one example, a user with a higher risk score may present a greater risk to the organization and a user with a lower risk score may present a lower risk to the organization. In an implementation, user data storage 242 may store information related to one or more groups of users (which may also be referred to as static groups, smart groups, dynamic groups, secure smart groups). In an example, a smart group, dynamic group, or secure smart group may be a query-based group that accurately and automatically builds a list of users that meet specified criteria at the moment that the group is created, requested, or used.

In an implementation, workflow storage 244 may store workflows that have been created or designed in the past. In an example, workflow storage 244 may store workflows that have been preconfigured in security awareness and training platform 202, for example workflows created by security threat researchers for use by security awareness and training platform 202, which in examples may be referred to as ‘system workflows’. In some examples, workflow storage 244 may store workflows that system administrators may have previously designed. For example, workflow storage 244 may store workflows for an organization were created by a member of the organization, in addition to one or more system workflows. In examples, workflow storage 244 may store workflows that were created by any organization, where the creating organization consents to providing the workflow for use by other organizations, for example in a ‘crowd-sourced’.

According to an implementation, simulated phishing template storage 246 may store simulated phishing templates. In examples, a simulated phishing template customized by a system administrator may be stored in simulated phishing template storage 246 such that the simulated phishing template can be used for multiple different users in the organization over a period of time or for different campaigns. In some examples, the system administrator may select a simulated phishing template from a pool of available simulated phishing templates stored in simulated phishing template storage 246 and may send a “stock” template to users unchanged.

In an example, information related to policies of the organization stored in policy storage 240, information related to users of the organization stored in user data storage 242, workflows stored in workflow storage 244, and simulated phishing templates stored in simulated phishing template storage 246 may be periodically or dynamically updated as required. In an implementation, policy storage 240, user data storage 242, workflow storage 244, and simulated phishing template storage 246 may include any type or form of storage, such as a database or a file system or coupled to memory 122 or cache 140.

According to an embodiment, endpoint security system 204 may be a system (or one or more systems) that is/are implemented by an organization to monitor nodes or endpoints of the network that are closest to an end user device, for example for compliance with security standards. An ‘endpoint’ is any device that is physically an end point on a computer network. Examples of endpoints are laptops, desktop computers, mobile phones, tablet devices, servers, and virtual environments. Examples of endpoint security services provided by an endpoint security system include antivirus software, email filtering, web filtering, and firewall services. In an example, endpoint security system 204 may also provide protection from cybersecurity threats posed by lack of compliance with security standards on the endpoints. In an implementation, endpoint security system 204 may include a secure email gateway or other system deployed by an organization. In an example, endpoint security system 204 may be a third-party system. In an implementation, endpoint security system 204 may operate to protect the organization by detecting, intercepting, or recording risky actions of users of the organization. In an implementation, endpoint security system 204 may be configured to block or record user actions that may expose the organization to risk or that may violate the policies or rules of the organization. Examples of activities that endpoint security system 204 may block or record include network traffic going to Uniform Resource Locators (URLs) that are not allowed (i.e., that are blacklisted), peer to peer traffic connecting to certain ports, user access to an insecure File Transfer Protocol (FTP) server, a direct terminal connection (for example, with telnet) with unencrypted traffic, use of unencrypted protocols (for example, http://) when encrypted protocols (for example, https://) are available, violation of company security policies (for example, the use of thumb drives or use of certain file extensions), execution of unsigned code, execution of code downloaded from the Internet, and traffic from non-secure networks (for example, not using a Virtual Private Network (VPN) to connect to devices). Known examples of endpoint security system 204 include CrowdStrike™ Falcon (Austin, Texas), Palo Alto Networks (Santa Clara, California), NetSkope NewEdge (Santa Clara, California), Zscaler (San Jose, California), SentinelOne Singularity Platform (Mountainview, California), Kaspersky Endpoint Security (Moscow, Russia), or Broadcom Symantec Endpoint Protection (San Jose, California).

According to some embodiments, endpoint security system 204 may include processor 250 and memory 252. For example, processor 250 and memory 252 of endpoint security system 204 may be CPU 121 and main memory 122, respectively as shown in FIG. 1C and FIG. 1D. In some embodiments, endpoint security system 204 may include event data storage 254. In an implementation, event data storage 254 may store event data of users in an organization. In examples, event data storage 254 may store user actions that may expose an organization to risk or that may violate policies or rules of the organization. In some implementations, event data storage 254 may store information related to security incidents. A security incident is an incident within an organization that affects a user which is related to the security domain of the organization. Examples of security incidents include unauthorized attempts to access systems or data, privilege escalation attacks, phishing attacks, malware attacks, Denial-of-Service (DoS) attacks, man in the middle attacks, and password attacks. In an implementation, information stored in event data storage 254 may be periodically or dynamically updated as required. According to an implementation, event data storage 254 may include any type or form of storage, such as a database or a file system or coupled to memory 552.

Referring back to FIG. 2, in some embodiments, administrator device 206 may be any device used by a system administrator or a security administrator to perform administrative duties. Administrator device 206 may be any computing device, such as a desktop computer, a laptop, a tablet computer, a mobile device, a Personal Digital Assistant (PDA), smart glasses, or any other computing device. In an implementation, administrator device 206 may be a device, such as client device 102 shown in FIG. 1A and FIG. 1B. Administrator device 206 may be implemented by a device, such as computing device 100 shown in FIG. 1C and FIG. 1D. According to some embodiments, administrator device 206 may include processor 256 and memory 258. In an example, processor 256 and memory 258 of administrator device 206 may be CPU 121 and main memory 122, respectively, as shown in FIG. 1C and FIG. 1D. Administrator device 206 may also include user interface 260, such as a keyboard, a mouse, a touch screen, a haptic sensor, a voice-based input unit, or any other appropriate user interface. It shall be appreciated that such components of administrator device 206 may correspond to similar components of computing device 100 in FIG. 1C and FIG. 1D, such as keyboard 126, pointing device 127, I/O devices 130a-n and display devices 124a-n. Administrator device 206 may also include display 264, such as a screen, a monitor connected to the device in any manner, a wearable glass, or any other appropriate display. In some implementations, administrator device 206 may include an administrator interface 266. Administrator interface 266 may be supported by a library, an application programming interface (API), a set of scripts, or any other code that may enable the system administrator to manage security awareness and training platform 202.

Referring again to FIG. 2, in some embodiments, user device 208-(1-N) may be any device used by a user (all devices of user device 208-(1-N) are subsequently referred to as user device 208-1 however, the description may be generalized to any of user device 208-(1-N)). The user may be an employee of an organization, a client, a vendor, a customer, a contractor, or any person associated with the organization. User device 208-1 may be any computing device, such as a desktop computer, a laptop, a tablet computer, a mobile device, a Personal Digital Assistant (PDA), or any other computing device. In an implementation, user device 208-1 may be a device, such as client device 102 shown in FIG. 1A and FIG. 1B. User device 208-1 may be implemented by a device, such as computing device 100 shown in FIG. 1C and FIG. 1D. According to some embodiments, user device 208-1 may include processor 268-1 and memory 270-1. In an example, processor 268-1 and memory 270-1 of user device 208-1 may be CPU 121 and main memory 122, respectively, as shown in FIG. 1C and FIG. 1D. User device 208-1 may also include user interface 272-1, such as a keyboard, a mouse, a touch screen, a haptic sensor, a voice-based input unit, or any other appropriate user interface. It shall be appreciated that such components of user device 208-1 may correspond to similar components of computing device 100 in FIG. 1C and FIG. 1D, such as keyboard 126, pointing device 127, I/O devices 130a-n and display devices 124a-n. User device 208-1 may also include display 274-1, such as a screen, a monitor connected to the device in any manner, or any other appropriate display. In an implementation, user device 208-1 may display received content (for example, a simulated phishing communication based on a simulated phishing template) for the user using display 274-1 and is able to accept user interaction via user interface 272-1 responsive to the displayed content.

Referring again to FIG. 2, in some embodiments, user device 208-1 may include email client 276-1. In one example, email client 276-1 may be an application that can be accessed over network 262 without being installed on user device 208-1. In an implementation, email client 276-1 may be any application capable of composing, sending, receiving, and reading email messages. In an example, email client 276-1 may facilitate a user to create, receive, organize, and otherwise manage email messages. In an implementation, email client 276-1 may be an application that runs on user device 208-1. In some implementations, email client 276-1 may be an application that runs on a remote server or on a cloud implementation and is accessed by a web browser. For example, email client 276-1 may be an instance of an application that allows viewing of a desired message type, such as any web browser, Microsoft Outlook™ application (Microsoft, Mountain View, California), IBM® Lotus Notes® application, Apple® Mail application, Gmail® application (Google, Mountain View, California), WhatsApp™ (Facebook, Menlo Park, California), a text messaging application, or any other known or custom email application. In an example, a user of user device 208-1 may be mandated to download and install email client 276-1 by the organization. In another example, email client 276-1 may be provided by the organization as default. In some examples, a user of user device 208-1 may select, purchase and/or download email client 276-1 through an application distribution platform. In some examples, user device 208-1 may receive simulated phishing communications via email client 276-1. Other user devices 208-(2-N) may be similar to user device 208-1.

According to an embodiment, to facilitate orchestration of security awareness workflows, security awareness and training platform 202 may provide orchestration interface 228 (interchangeably referred to as interface 228) to a system administrator (also referred to as workflow orchestrator). In an example, orchestration interface 228 may be a menu-like interface or a design canvas that is presented to the system administrator for creation of security awareness orchestration workflows. A security awareness orchestration workflow may be a workflow designed to improve security posture of an organization by way of delivering responses to one or more targets following one or more users of the organization engaging in an action associated with a security incident.

In an implementation, the system administrator may select an existing workflow (for example, a workflow stored in workflow storage 244) as a starting point for further customization. In an example, workflows may be categorized by type. For example, workflows may be categorized into two types: system workflows and custom workflows. System workflows may be workflows that may have been preconfigured and provided to an organization as part of security awareness and training platform 202. Custom workflows may be workflows that system administrator(s) may have previously designed and saved. Accordingly, the system administrator may select a type of workflow for further configuration.

In an implementation, a plurality of system workflows and/or a plurality of custom workflows may be provided to the system administrator. In response, the system administrator may select one system workflow from amongst the plurality of system workflows, or one custom workflow from amongst the plurality of custom workflows as a starting point for further customization. In examples, the system administrator may further customize the system workflow or the custom workflow through element configuration. In an example, the system administrator may replace one or more elements in the selected system workflow or the selected custom workflow with different elements. An element may be one of a number of core aspects comprising a single workflow. In some examples, the system administrator may add additional elements to the selected system workflow or the selected custom workflow. In examples, the system administrator may select (for example by clicking) one or more elements of the selected system workflow or the selected custom workflow to access corresponding subelements and change the configuration of the elements or the subelements. A subelement may be a specific aspect of several aspects corresponding to an element of a workflow, by selection of which a system administrator may further customize the element. In some examples, the system administrator may delete elements of the selected system workflow or the selected custom workflow for further customization. According to some embodiments, the system administrator may choose to create a new workflow instead of selecting an existing workflow (e.g., a system workflow or a custom workflow).

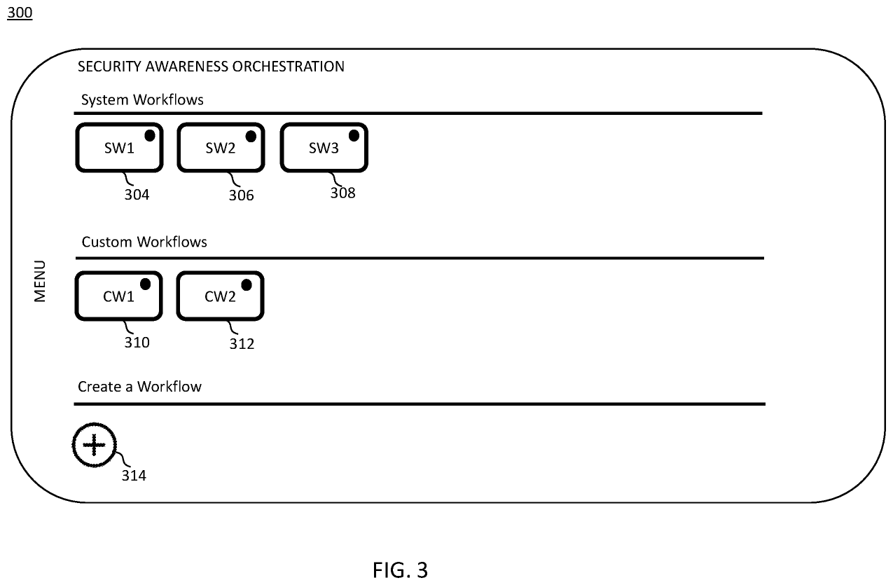

FIG. 3 depicts menu 300 for creation of security awareness orchestration workflows, according to some embodiments. In particular, FIG. 3 shows menu 300 for selection of an existing workflow and/or creation of a new security awareness orchestration workflow. As shown in the example of FIG. 3, menu 300 presented to a system administrator includes three system workflows including a first system workflow (SW1) (represented by reference numeral 304), a second system workflow (SW2) (represented by reference numeral 306), and a third system workflow (SW3) (represented by reference numeral 308). The system workflows are displayed under a “System Workflows” heading. Further, menu 300 includes two custom workflows including a first custom workflow (CW1) (represented by reference numeral 310) and a second custom workflow (CW2) (represented by reference numeral 312). The custom workflows are displayed under a “Custom Workflows” heading in menu 300.

In examples, system workflows SW1 (304), SW2 (306), and SW3 (308), and custom workflows CW1 (310) and CW2 (312) are existing workflows. In an implementation, the system administrator may select one or more of system workflows SW1 (304), SW2 (306), and SW3 (308), or one or more of custom workflows CW1 (310) and CW2 (312) as a starting point for a new workflow, and further customize elements of the selected one or more system workflows or one or more custom workflows through element configuration.

According to some embodiments, the system administrator may choose to create a new workflow by interacting with menu 300. In an example, the system administrator may choose to create a new workflow using button 314 provided under a “Create a Workflow” heading in menu 300.

According to an embodiment, orchestration interface 228 as shown in FIG. 2, may receive input from the system administrator. In an example, the input may be selection of an existing workflow. In an example, the system administrator may select system workflow SW1 (304). Upon receiving the input, orchestration interface 228 may display system workflow SW1 (304) on a canvas. A canvas may be an interface workspace displayed to a system administrator upon his or her selection of a type of workflow for configuration. The system administrator can begin to customize the system workflow SW1 (304) by selecting (by clicking on) individual elements or hovering over individual elements of the system workflow SW1 (304). Each of these individual elements can be changed or configured by the system administrator. After the system administrator has finished customizing the system workflow SW1 (304), the system administrator may be prompted to save the adapted system workflow under a different name. In an example, the system administrator may save the adapted system workflow under the name “SW4” for future references.

According to some implementations, orchestration interface 228 may receive an indication from the system administrator to create a new workflow for automating a response to one or more users engaging in an action associated with a security incident. In an implementation, upon receiving the indication to create the workflow, orchestration interface 228 may present a blank canvas to the system administrator.

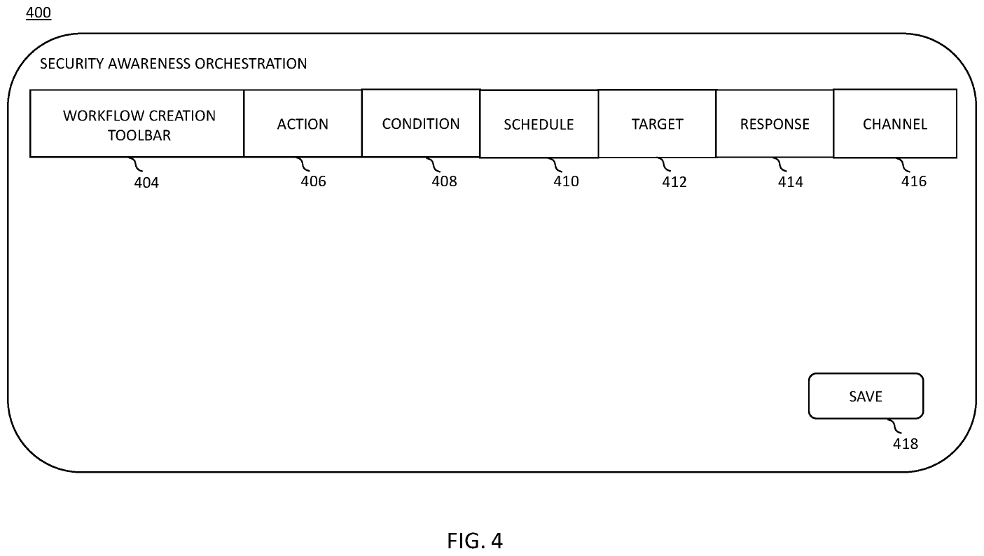

FIG. 4 illustrates interface canvas 400 for creating new workflows, according to some embodiments. An interface canvas 400 may also be used for modifying or configuring existing workflows. In examples, if a system administrator chooses to create a new workflow, for example, by clicking on button 314 provided under the “Create a Workflow” heading in FIG. 3, then the system administrator may be presented with canvas 400. As shown in FIG. 4, canvas 400 includes workflow creation toolbar 404. In an example, a workflow creation toolbar may be a graphic representation that displays elements that may be used to create a workflow for configuration by a system administrator.

In examples, workflow creation toolbar 404 may include six elements which may be used to create the workflow. It shall be understood that the number of elements in the workflow may be greater than six or may be fewer than six, and that workflow creation toolbar 404 comprising six elements as shown in FIG. 4 is an illustrative example. The six elements shown in the example of FIG. 4, one or more of which may be configurable by a system administrator, include an action element, a condition element, a schedule element, a target element, a response element, and a channel element. In an example, the action element may represent behavior of a user of an organization that may be tracked or that, in examples, poses a security risk to the organization, and therefore may trigger a security awareness orchestration workflow. In an example, the condition element may represent criteria applied to a user action whereby fulfillment of the criteria is required for the user action to trigger a workflow. In an example, the schedule element may represent a timing and/or a periodicity for delivering of one or more responses to a target of a workflow. In an example, the target element may refer to a single user or multiple users of an organization to which a response of a workflow will be delivered. In an example, the response element may refer to the outcome of a workflow. For example, response may be delivery of security awareness training to a target or updating of user permissions of the target. In an example, the channel element may refer to a medium through which a response is delivered to a target.

In an implementation, each element may be represented by a tab or selectable element of workflow creation toolbar 404 and configuration of these elements may be made available to the system administrator by the system administrator clicking on, or hovering over, the tab or selectable element. In an example, the action element may be represented by action tab 406, the condition element may be represented by condition tab 408, the schedule element may be represented by schedule tab 410, the target element may be represented by target tab 412, the response element may be represented by response tab 414, and the channel element may be represented by channel tab 416.

Referring to FIG. 4, the system administrator can begin to create the workflow by clicking on, or hovering over, any of the tabs such as action tab 406, condition tab 408, schedule tab 410, target tab 412, response tab 414, or channel tab 416 which represent an example of individual elements which may be used to create a workflow. Each of these individual elements can be changed or configured by the system administrator. Further, the system administrator may save the workflow that he or she is working on using save button 418.

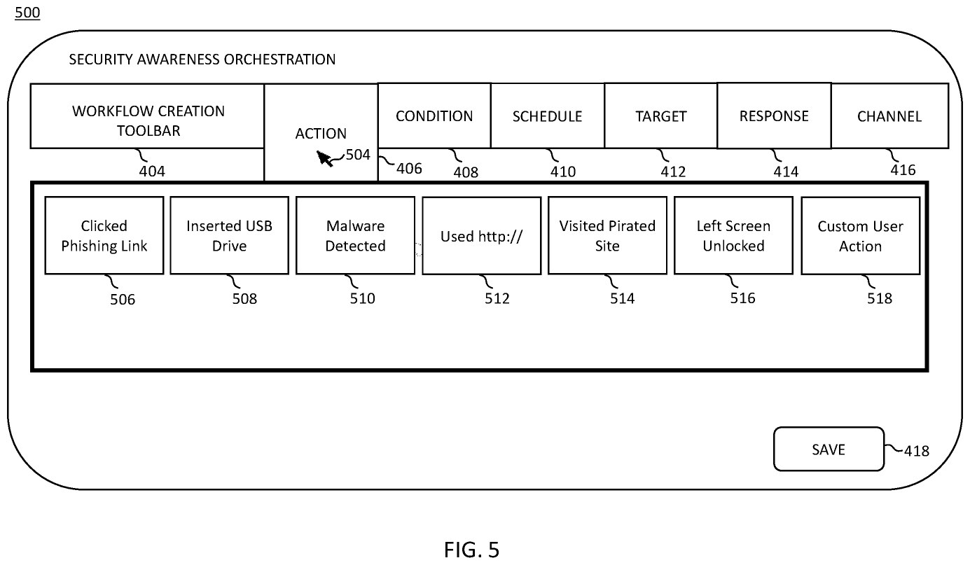

FIG. 5 illustrates interface canvas 500 describing the action element of workflow creation toolbar 404, according to some embodiments.

As described earlier, the action element may be represented by action tab 406 of workflow creation toolbar 404. In an implementation, if a system administrator clicks on, or hovers over, action tab 406 of workflow creation toolbar 404, a plurality of selectable actions that a user of one or more users may perform may be provided on canvas 500 for the system administrator to select from. In an example, the system administrator may select an action associated with a security incident from the plurality of selectable actions. The selected action may be configured into a workflow and configured to trigger execution of the workflow by the user of the one or more users taking or performing the selected action. In an implementation, orchestration interface 228 may receive a selection of the action associated with the security incident from the plurality of selectable actions associated with the security incident from the system administrator.

In examples, the selectable actions may be user actions that pose security risks to an organization and which when performed by a user may reveal gaps in the user's security awareness. Further, the action that may be selected may represent security threats that occur in an organizations' ecosystem. In an example, each action may represent a potential security threat or policy violation. In an implementation, each action may further be configured by the system administrator according to a number of subelements which are specific to the action element and accessible to the system administrator via clicking on, or hovering over, the subelement in the expanded area of workflow creation toolbar 404.

In examples, if the system administrator clicks on or hovers over action tab 406 of workflow creation toolbar 404, for example, using mouse pointer 504 as shown in FIG. 5, a number of subelements which are specific security related actions that may have been performed by a user are presented to the system administrator. The subelements may include “clicked phishing link” subelement, “inserted USB drive” subelement, “malware detected” subelement, “used http://” subelement, “visited pirated site” subelement, and “left screen unlocked” subelement. According to an implementation, one or more sub element may be further configured.

In an implementation, each subelement may be represented by a tab of workflow creation toolbar 404 and configuration of one or more of these subelements may be made available to the system administrator by the system administrator clicking on or hovering over the tab.

In an example, the “clicked phishing link” subelement may be represented by “clicked phishing link” tab 506, the “inserted USB drive” subelement may be represented by “inserted USB drive” tab 508, the “malware detected” subelement may be represented by “malware detected” tab 510, the “used http://” subelement may be represented by “used http://” tab 512, the “visited pirated site” subelement may be represented by “visited pirated site” tab 514, and the “left screen unlocked” element may be represented by “left screen unlocked” tab 516. In an implementation, to input a more customized action or criteria for action that is not one of the sub elements, the system administrator may click on “custom action” tab 518. In an example, if the system administrator clicks on “custom action” tab 518, then the system administrator is enabled to define a new action. The new action may be saved as a new subelement and may appear on canvas 500 as a selectable action in future.

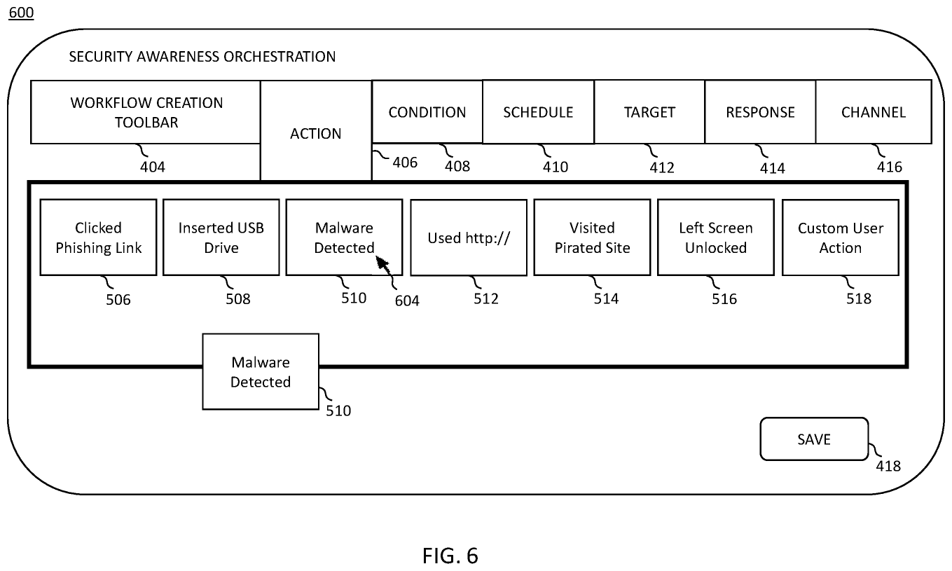

FIG. 6 illustrates interface canvas 600 where a system administrator has selected “Malware Detected” tab 510 by clicking on or hovering over “Malware Detected” tab 510 using mouse pointer 604 as shown in FIG. 6. In an example, “Malware Detected” tab 510 (or the “Malware Detected” subelement) may be dropped or moved onto an open portion of the canvas 600 in order to be added to a workflow. In an implementation, once “Malware Detected” subelement is added to the workflow, the system administrator may be able to further configure it.

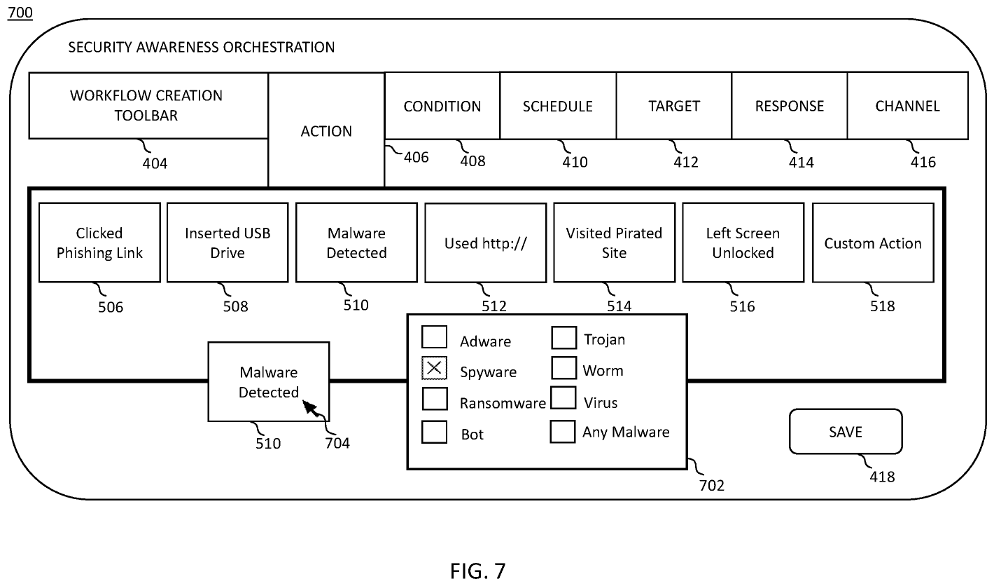

FIG. 7 illustrates canvas 700 showing drop-down menu 702 (or pop-up menu 702) for further configuration of “Malware Detected” subelement, according to some embodiments. In an implementation, if the system administrator clicks on, or hovers over, “Malware Detected” tab 510 using mouse pointer 704 as shown in FIG. 7, the “Malware Detected” subelement is dropped onto canvas 700. As a result, drop-down menu 702 is displayed for further configuration of the “Malware Detected” subelement. In examples, various types of malware that the system administrator can select may appear in drop-down menu 702. As shown in FIG. 7, various types of malware include, but are not limited, to “Adware”, “Spyware”, “Ransomware”, “Trojan”, “Worm”, “Virus” and “Bot”. In examples, the ability to further specify a subelement related to a specific action gives the system administrator an ability to customize the workflow in great detail. In an example, the “Malware Detected” subelement may have a default configuration, and if the system administrator does not further configure the “Malware Detected” subelement, then the default configuration may be applied. For example, for the “Malware Detected” subelement, the default configuration may be “Spyware”, which is selectable in the configuration of the “Malware Detected” subelement. In an implementation, after specifying a specific type/feature of the “Malware Detected” subelement, the system administrator may click on save button 418. In example, saving the selection implements the specific type/feature of the “Malware Detected” subelement into the workflow, for example by saving the configured element on the canvas such that it can later be connected with other elements to create a workflow.

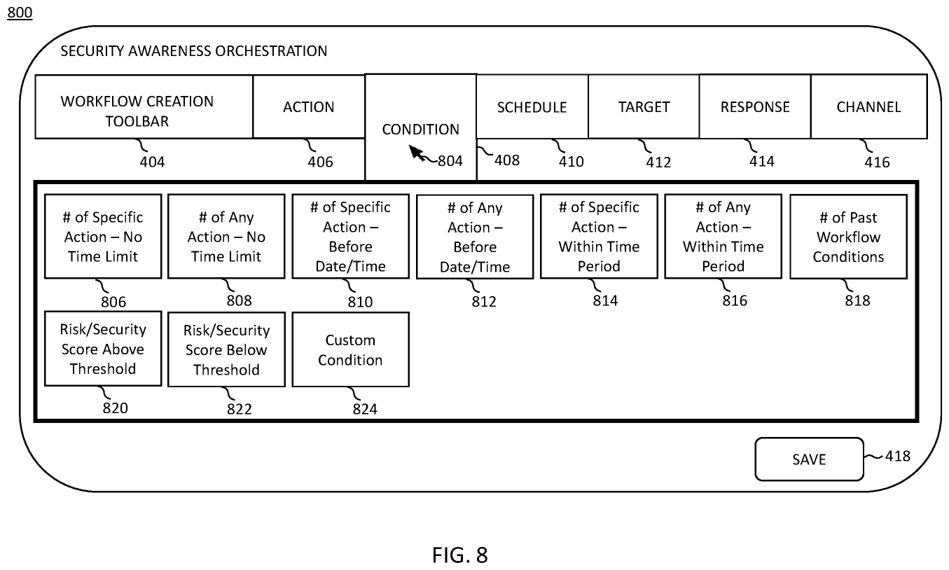

FIG. 8 illustrates interface canvas 800 describing the condition element of workflow creation toolbar 404, according to some embodiments.

As described earlier, the condition element may be represented by condition tab 408 of workflow creation toolbar 404. In an implementation, if the system administrator clicks on, or hovers over, condition tab 408 of workflow creation toolbar 404, for example, using mouse pointer 804 as shown in FIG. 8, a plurality of selectable conditions to be applied to a security threat or policy violation associated with a user as specified in an action are provided on canvas 800 for the system administrator to select from. In examples, the plurality of selectable conditions may allow the system administrator to restrict the triggering of a workflow by an action to occur only if the action complies with a condition related to a user performing the action (including frequency (#) and date/time), to attributes of the user, or to outcomes of past workflows. In an implementation, the system administrator may select one or more conditions from the plurality of selectable conditions. In an implementation, orchestration interface 228 may receive a selection of the one or more conditions from the plurality of selectable conditions from the system administrator. The selected conditions may be configured into the workflow and configured to trigger one of execution of or progression through the workflow.

In an implementation, each condition may be further configured by the system administrator according to a number of subelements which are specific to the condition element and accessible to the system administrator via clicking on, or hovering over, the subelement in the expanded area of workflow creation toolbar 404. In examples, if the system administrator clicks on condition tab 408 of workflow creation toolbar 404, a number of subelements are presented. The subelements may include “#of specific action-no time limit” subelement, “#of any action-no time limit” subelement, “#of specific action-before date/time” subelement, “#of any action-before date/time” subelement, “#of specific action-within time period” subelement, “#of any action-within time period” subelement, “#of past workflow conditions” subelement, “risk/security score above threshold” subelement and “risk/security score below threshold” subelement. In an implementation, each subelement may be represented by a tab of workflow creation toolbar 404, and configuration of these subelements may be made available to the system administrator by the system administrator clicking on, or hovering over, the tab.

In an example, the “#of specific action-no time limit” subelement may be represented by “#of specific action-no time limit” tab 806, the “#of any action-no time limit” subelement may be represented by “#of any action-no time limit” tab 808, the “#of specific action-before date/time” subelement may be represented by “#of specific action-before date/time” tab 810, the “#of any action-before date/time” subelement may be represented by “#of any action-before date/time” tab 812, the “#of specific action-within time period” subelement may be represented by “#of specific action-within time period” tab 814, the “#of any action-within time period” subelement may be represented by “#of any action-within time period” tab 816, the “#of past workflow conditions” subelement may be represented by “#of past workflow conditions” tab 818, the “risk/security score above threshold” subelement may be represented by “risk/security score above threshold” tab 820, and the “risk/security score below threshold” subelement may be represented by “risk/security score below threshold” tab 822. In an implementation, to input a more customized condition or criteria for a condition that is not one of the subelements, the system administrator may click on “custom condition” tab 824. In an example, if the system administrator clicks on “custom condition” tab 824, then the system administrator is enabled to define a new condition. The new condition may be saved as a new subelement and may appear on canvas 500 as a selectable condition in future.

In some embodiments, it may be orchestrated that a user's action customized using the action element only triggers the progression of the workflow when the action is performed a number of times. This orchestration may be achieved by adding a condition element to the workflow by the system administrator. In an example, to achieve the triggering of a workflow by a specific action only when its occurrence exceeds or matches a given frequency, the system administrator may select “#of specific action-no time limit” tab 806. In some examples, it may be orchestrated that the user's action triggers the workflow only if the frequency of its occurrence reaches a given number and those occurrences happen before a given time date or time. To achieve this, the system administrator may select the “#of specific action-before date/time” tab 810. To specify what value the “#” should take on, the system administrator may click on the condition element and a subelement pop-up or drop-down menu may appear which allows the system administrator to configure the condition element.

In examples, to configure the “#of specific action-within time period” subelement, the system administrator may need to configure both the frequency (#) of an action's occurrence and the time period within which it occurred. The action that a condition subelement is applicable to is determined by the action subelement on the canvas that the condition subelement is connected to in the workflow. In some examples, a condition subelement may be added to a workflow that does not depend upon an action subelement. For example, a system administrator may select “#of any action-no time limit” tab 808. As the condition applies to ‘any action’, the count for which the trigger is applicable increments any time the user performs any action subelement from action tab 406. As with other condition subelements, condition subelements that do not require an action can be further configured by clicking on, or hovering over, them and choosing configuration parameters from the pop-up or drop-down menu that is displayed on the interface.

In an example, a system administrator may integrate a condition subelement into a workflow that is applicable to the users themselves. In this case, the workflow may only be triggered when the user who performs the action subelement also meets the condition subelement. An example of a user condition subelement is “risk/security score above threshold’. With this condition subelement, the workflow may only be triggered if the user performs the action subelement and the user's risk/security score is above the threshold, where the threshold is configured by the system administrator by clicking on the user condition subelement and entering configuration information. User attributes and other user information that may be selected in creating a user condition subelement may be stored in user data storage 242.

In an implementation, the “#of past workflow conditions” condition subelement may be applied to a workflow in its totality. In configuring the “#of past workflow conditions” condition subelement, the workflow to which the condition applies to may be specified. The workflow may be identified by the name of the workflow, an identifier of the workflow, or some other unique attribute of the workflow, such as a handle. The system administrator may therefore configure the “#of past workflow conditions” condition subelement such that if a user performs the action subelement, the workflow will only be triggered if the workflow specified in the “#of past workflow conditions” condition subelement configuration has been triggered the “#” of times specified in the “#of past workflow conditions” condition subelement configuration.

In an implementation, after selection of one or more condition subelements, the system administrator may click on save button 418. As a result, the selected one or more condition subelements are implemented into the workflow.

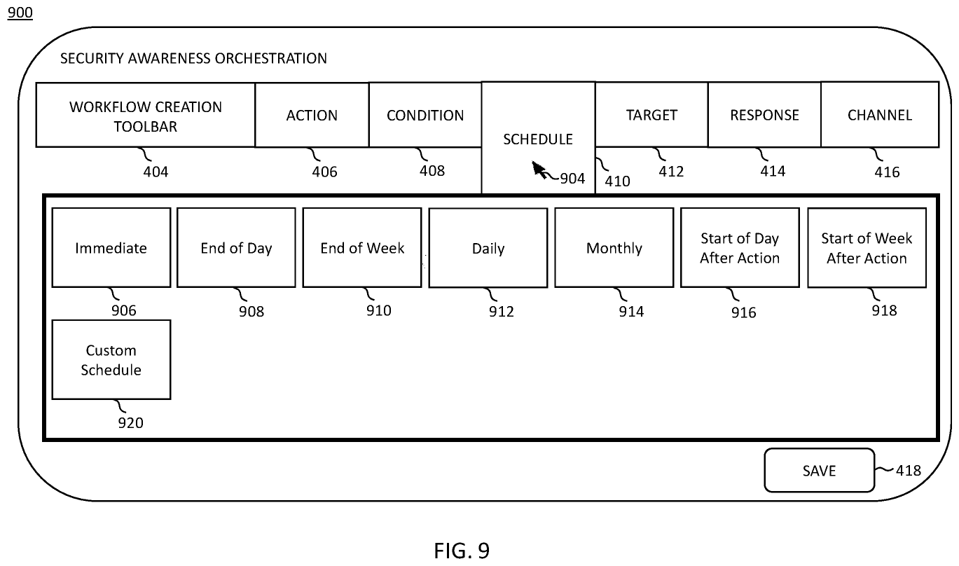

FIG. 9 illustrates canvas 900 describing the schedule element of workflow creation toolbar 404, according to some embodiments.

As described earlier, the schedule element may be represented by schedule tab 410 of workflow creation toolbar 404. In an example, a system administrator may choose to configure a workflow, such that a response associated by the workflow with a user performing an action is delivered at a certain time, for example, by selecting a schedule with schedule tab 410. A schedule may be a timing or a periodicity for delivering one or more responses to one or more targets of a workflow. The schedule may be configurable by a system administrator. In an example, response may be an outcome of a workflow. For example, the response may be delivering of security awareness training to a target or updating of user permissions of the target. In examples, a target may be a user or users of an organization to whom a response of a workflow may be delivered. In examples, the schedule element may allow the system administrator to include scheduling information for when the response subelements to the action subelements in the workflow are delivered. Examples of schedules for delivering of responses after user actions include, but are not limited to, immediate, end of day, end of week, daily, monthly, start of day after action, and start of week after action.

In an implementation, if the system administrator clicks on, or hovers over, schedule tab 410 of workflow creation toolbar 404, for example, using mouse pointer 904 as shown in FIG. 9, a plurality of selectable schedules are provided on canvas 900 for the system administrator to select from. In response, the system administrator may select a schedule from the plurality of schedules. In examples, the system administrator may select a schedule from the plurality of schedules for each response of the one or more responses in the workflow. In an implementation, orchestration interface 228 may receive a selection of the schedule from the plurality of selectable schedules from the system administrator. The selected schedule may be configured into the workflow to cause selected response to be sent by the workflow to one or more targets according to the selected schedule.

According to an implementation, each schedule may be further configured by the system administrator according to a number of subelements which are specific to the schedule element and accessible to the system administrator via clicking on, or hovering over, the subelement in the expanded area of workflow creation toolbar 404. In examples, if the system administrator clicks on schedule tab 410 of workflow creation toolbar 404, a number of schedule subelements are presented. The schedule subelements may include “immediate” schedule subelement, “end of day” schedule subelement, “end of week” schedule subelement, “daily” schedule subelement, “monthly” schedule subelement, “start of day after action” schedule subelement, and “start of week after action” schedule subelement. In an implementation, each schedule subelement may be represented by a tab of workflow creation toolbar 404, and configuration of these schedule subelements may be made available to the system administrator by the system administrator clicking on or hovering over the tab.

In an example, the “immediate” schedule subelement may be represented by “immediate” tab 906, the “end of day” schedule subelement may be represented by “end of day” tab 908, the “end of week” schedule subelement may be represented by “end of week” tab 910, the “daily” schedule subelement may be represented by “daily” tab 912, the “monthly” subelement may be represented by “monthly” tab 914, the “start of day after action” schedule subelement may be represented by “start of day after action” tab 916, and the “start of week after action” schedule subelement may be represented by “start of week after action” tab 918.

In an example, a response specified in a response subelement in the workflow may be delivered to a target immediately after the action subelement is performed if the system administrator has added the “immediate” schedule subelement to the workflow. In some examples, the system administrator may add the “start of week after action” schedule subelement to the workflow, which indicates that a response specified in a response subelement in the workflow will be delivered to the target at the beginning or start of the week after the action element in the workflow was triggered. In examples, a periodicity for the response to be delivered may also be scheduled using the “daily” schedule subelement, the “weekly” schedule subelement, and/or the “monthly” schedule subelement. In an implementation, a system administrator may be able to create a custom schedule by clicking on, or hovering over, “custom schedule” tab 920. In examples, the system administrator may be provided with an interface through which the system administrator could create the custom schedule. In an implementation, after selection of one or more schedule subelements, the system administrator may click on save button 418. As a result, the selected one or more schedule subelements are implemented into the workflow.

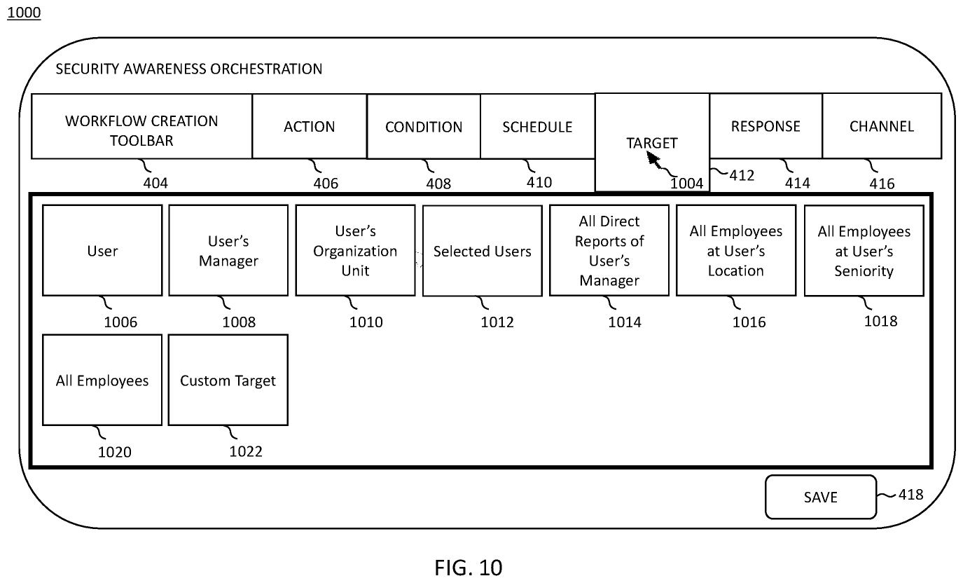

FIG. 10 illustrates interface canvas 1000 describing the target element of workflow creation toolbar 404, according to some embodiments.

As described earlier, the target element may be represented by target tab 412 of workflow creation toolbar 404. In examples, target tab 412 of workflow creation toolbar 404 may allow a system administrator to specify to which user(s) the response of the workflow will be delivered. Examples of targets include, but are not limited to, user, user's manager, user's organization unit, selected users, all direct reports of user's manager, all employees at user's location, all employees at user's seniority, and all employees. In examples, the responses may be sent only to the user that performed the action, or the responses may be sent more broadly, for example, to the user's manager (and not the user), to users in the same organization unit as the user that performed the action, to a selected group of users, and/or to users according to a smart group.

In an implementation, orchestration interface 228 may receive an input of the one or more targets to configure into the workflow, the one or more targets identifying one or more users or groups of users to which the workflow sends the response.

In examples, if the system administrator clicks on target tab 412 of workflow creation toolbar 404, for example, using mouse pointer 1004 as shown in FIG. 10, a number of target subelements are presented. The target subelements may include “user” target sub element, “user's manager” target sub element, “user's organization unit” target subelement, “selected users” target subelement, “all direct reports of user's manager” target subelement, “all employees at user's location” target subelement, “all employees at user's seniority” target subelement, and “all employees” target subelement. In an implementation, each target subelement may be represented by a tab of workflow creation toolbar 404, and configuration of these target subelements may be made available to the system administrator by the system administrator clicking on, or hovering over, the tab.

In an example, the “user” target subelement may be represented by “user” tab 1006, the “user's manager” target subelement may be represented by “user's manager” tab 1008, the “user's organization unit” target subelement may be represented by “user's organization unit” 1010, the “selected users” target subelement may be represented by “selected users” tab 1012, the “all direct reports of user's manager” target subelement may be represented by “all direct reports of user's manager” tab 1014, the “all employees at user's location” target subelement may be represented by “all employees at user's location” tab 1016, the “all employees at user's seniority” target subelement may be represented by “all employees at user's seniority” tab 1018, and the “all employees” target subelement may be represented by “all employees” tab 1020. In an implementation, the system administrator creating the workflow may also have an option of inputting a custom target using “custom target” tab 1022. In an example, if the system administrator selects “custom target” tab 1022, the system administrator may be presented with the active directory of the organization and may be able to select one or more individual users from the active directory to become the target for the workflow. In an example, if the system administrator selects “custom target” tab 1022, the system administrator may be presented with the organizational chart of the organization and may be able to select one or more organizational elements from the organizational chart of the organization to become the target for the workflow. For example, the system administrator could select the “finance” organization, or the “engineering” organization, or the “sales” organization of the organizational chart to become the target for the workflow. In an example, if the system administrator selects one or more organizational elements from an organizational chart to become a target for the workflow, the system administrator may be presented with a user interface (for example a pop-up) which lists all the users that belong to the organizational element, and the system administrator may be able to choose one or more users of the organizational element to become a target for the workflow. In an implementation, after selection of one or more target subelements, the system administrator may click on save button 418. As a result, the selected one or more target subelements are implemented into the workflow.

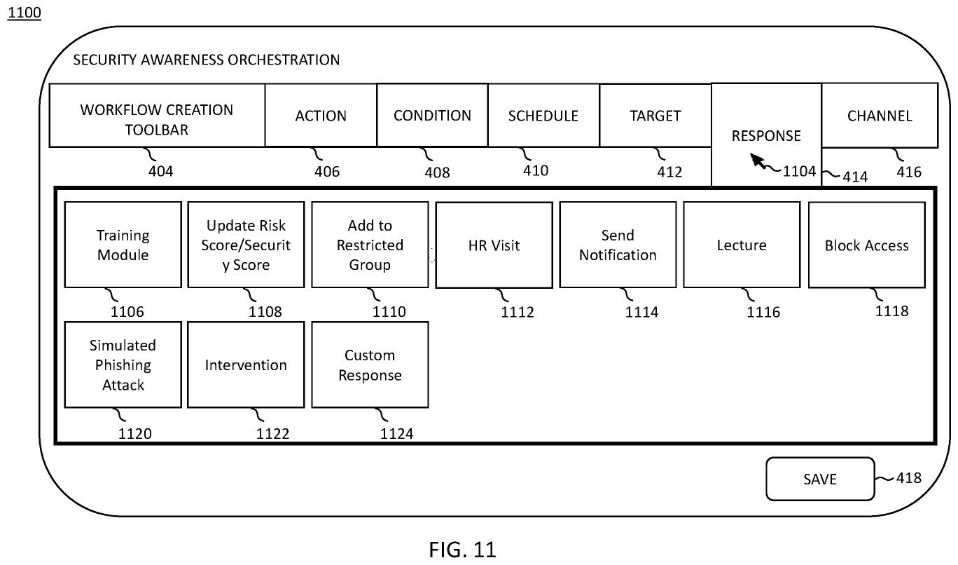

FIG. 11 illustrates interface canvas 1100 describing the response element of workflow creation toolbar 404, according to some embodiments.

As described earlier, the response element may be represented by response tab 414 of workflow creation toolbar 404. In examples, response tab 414 of workflow creation toolbar 404 may allow a system administrator to select one or more responses associated with one or more targets following a user performing the specified action (the action complying with the specified condition where a condition element is part of the workflow). The one or more responses associated with the one or more targets may involve changing the target's access to certain permissions within the organization. Examples of responses include, but are not limited to, a required training module, the update of a risk score or security score of the target, adding the target to a restricted group, an HR visit to the target, sending one or more notifications to the target, requiring the target to attend or participate in a lecture, blocking a target's access to one or more computer systems or applications, sending one or more simulated phishing attacks to the target, or any other intervention or education. In examples, the responses (for instance, various forms of training or coaching, or responses that involve limiting or blocking target accessibilities) may be delivered to a target according to the schedule associated with the target in the workflow, when the action occurs.

In examples, if the system administrator clicks on response tab 414 of workflow creation toolbar 404, for example, using mouse pointer 110 4 as shown in FIG. 11, a number of response subelements are presented. The response subelements may include “training module” response subelement, “update risk score/security” response subelement, “add to restricted group” response subelement, “HR visit” response subelement, “send notification” response sub element, “lecture” response subelement, “block access” response subelement, “simulated phishing attack” response subelement, and “intervention” response subelement. In an implementation, each response subelement may be represented by a tab of workflow creation toolbar 404, and configuration of these response subelements may be made available to the system administrator by the system administrator clicking on or hovering over the tab.

In an example, the “training module” response subelement may be represented by “training module” tab 1106, the “update risk score/security” response subelement may be represented by “update risk score/security” tab 1108, the “add to restricted group” response subelement may be represented by “add to restricted group” tab 1110, the “HR visit” response subelement may be represented by “HR visit” tab 1112, the “send notification” response subelement may be represented by “send notification” tab 1114, the “lecture” response subelement may be represented by “lecture” tab 1116, the “block access” response subelement may be represented by “block access” tab 1118, the “simulated phishing attack” response subelement may be represented by “simulated phishing attack” tab 1120, and the “intervention” response subelement may be represented by “intervention” tab 1122. In an implementation, the system administrator may also have an option of customizing the response using “custom response” tab 1124. In an implementation, after selection of one or more response subelements, the system administrator may click on save button 418. As a result, the selected one or more response subelements are implemented into the workflow.

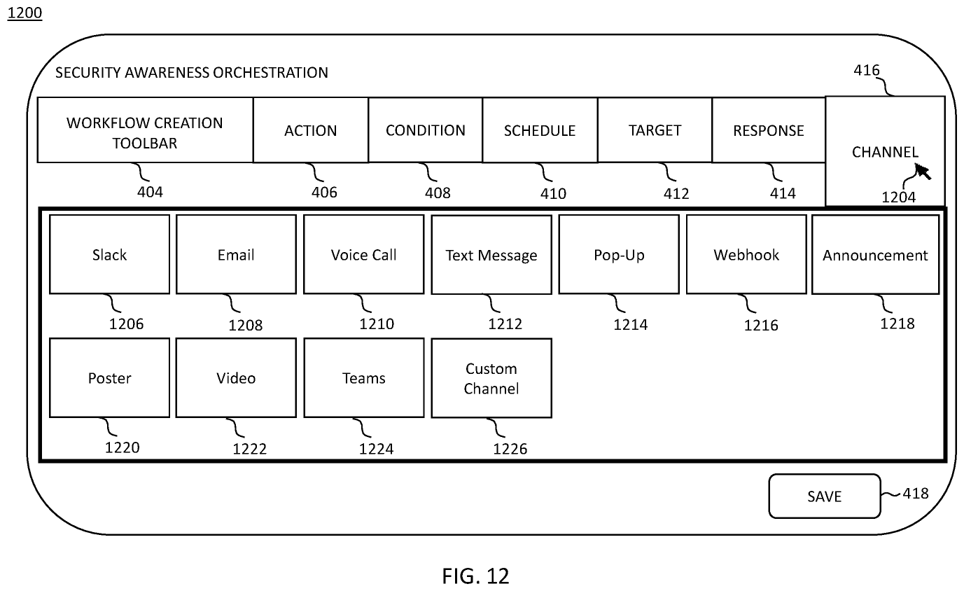

FIG. 12 illustrates canvas 1200 describing the channel element of workflow creation toolbar 404, according to some embodiments.

As described earlier, the channel element may be represented by channel tab 416 of workflow creation toolbar 404. In examples, channel tab 416 of workflow creation toolbar 404 may allow a system administrator to select or specify a channel through which a response is to be delivered to a target. In examples, a response may be sent through more than one channel to a target. Optionally, different responses may be associated with different channels in the workflow and may be sent to the same target or to different targets. Examples of channels include, but are not limited to, Slack (Slack Technologies, San Francisco, California), email, voice call, text message, pop-up, webhook, announcement, poster, video, and teams. In examples, if the system administrator clicks on channel tab 416 of workflow creation toolbar 404, for example, using mouse pointer 1204 as shown in FIG. 12, a plurality of channel subelements are presented. The channel subelements may include “slack” channel subelement, “email” channel subelement, “voice call” channel subelement, “text message” channel subelement, “pop-up” channel subelement, “webhook” channel sub element, “announcement” channel subelement, “poster” channel subelement, “video” channel subelement, and “teams” channel subelement. In an implementation, each channel subelement may be represented by a tab of workflow creation toolbar 404 and configuration of these channel subelements may be made available to the system administrator by the system administrator clicking on or hovering over the tab.

In an example, the “slack” channel subelement may be represented by “slack” tab 1206, the “email” channel subelement may be represented by “email” tab 1208, the “voice call” channel subelement may be represented by “voice call” tab 1210, the “text message” channel subelement may be represented by “text message” tab 1212, the “pop-up” channel subelement may be represented by “pop-up” tab 1214, the “webhook” channel subelement may be represented by “webhook” tab 1216, the “announcement” channel subelement may be represented by “announcement” tab 1218, the “poster” channel subelement may be represented by “poster” tab 1220, the “video” channel subelement may be represented by “video” tab 1222, and the “teams” channel subelement may be represented by “teams” tab 1224. In an implementation, the system administrator may also have an option of customizing the channel using “custom channel” tab 1226. In an implementation, after selection of one or more channel subelements, the system administrator may click on save button 418. As a result, the selected one or more channel subelements are implemented into the workflow.

According to an implementation, once the system administrator has configured each of the elements and subelements, the system administrator may connect these elements and subelements in the form of a workflow using a workflow designer workspace. The workflow designer workspace may be an interface that is displayed to a system administrator within which the system administrator may configure and connect elements and subelements of a workflow The workflow designer workspace may also be referred to as the canvas.

In an implementation, orchestration interface 228 may receive administrator input (for example, from system administrator) to connect any combination of elements (for example, action element, schedule element, response element, condition element, target element, and channel element) and subelements (action subelements, schedule subelements, response subelements, condition subelements, target subelements, and channel subelements) to create the workflow. In examples, orchestration interface 228 may receive administrator input to connect a selected action to a selected response to create a workflow.

According to an implementation, core unit 224 or action unit 226 as shown in FIG. 2 may be configured to establish the workflow to be executed to send the selected response automatically responsive to the performance of the selected action (according to a condition if configured) by a user of one or more users being detected. In some implementations, orchestration interface 228 may receive administrator input to arrange the selected elements and subelements on a canvas provided by orchestration interface 228. In examples, orchestration interface 228 may receive administrator input to arrange the selected action and the selected response on a canvas provided by orchestration interface 228.

According to an implementation, before or after customization of one or more elements and/or subelements, the system administrator may drag and drop any combination of the elements onto a workflow designer workspace to be connected manually by the system administrator using flow arrows. In an example, flow arrows are arrows with which a system administrator may connect workflow elements within a workflow designer workspace to create a workflow. In an example, in the case that the system administrator attempts to connect two aspects of the workflow that may not be connected, an error message may be displayed to the system administrator.

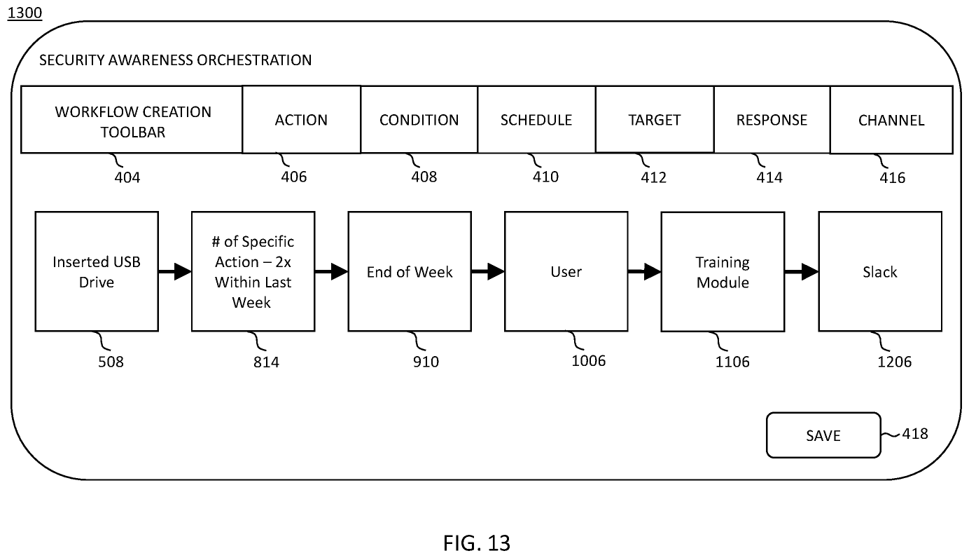

FIG. 13 illustrates example 1300 of a workflow within a workflow designer workspace, according to some embodiments.

In the example of FIG. 13, a system administrator creates a workflow by connecting one or more of an action subelement, a condition element, a schedule element, a target element, a response element, and a channel element, using flow arrows. As described in FIG. 13, in an example, the system administrator may connect “inserted USB drive” action subelement 508, “#of specific action-within time period” condition subelement 814, “end of week” schedule subelement 910, “user” target subelement 1006, “training module” response subelement 1106, and “slack” channel subelement 1206 to create a workflow.

In examples, the system administrator may create the workflow to be applied to a user (target) who inserted a USB drive (action) 2 times within the last week (condition). The workflow is constructed such that the training module (response) (the training module specific, for instance, to external drive usage training) is delivered to the user via a Slack channel (channel).

In some implementations, the system administrator may also be able to input details about the channel through which the response will be delivered or about the target to which the response will be delivered by clicking on channel or target components within the workflow designer workspace.

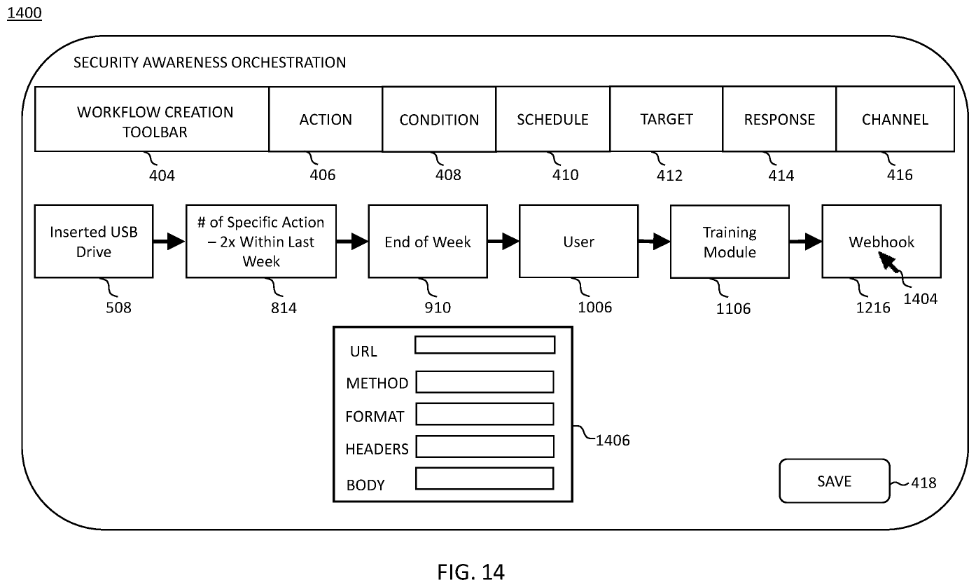

FIG. 14 illustrates example 1400 for further configuration of channel subelement within a workflow designer workspace, according to some embodiments.

In the example of FIG. 14, a system administrator creates a workflow by connecting “inserted USB drive” action subelement 508, “#of specific action-within time period” condition subelement 814, “end of week” schedule subelement 910, “user” target subelement 1006, “training module” response subelement 1106, and “webhook” channel subelement 1216. In examples, the system administrator may create the workflow to be applied to a user who inserted a USB drive (action) 2 times within the last week (condition). The workflow is constructed such that training module (response) (the training module specific, for instance, to external drive usage training) is delivered to the user (target) via a webhook (channel).

In examples, if the system administrator clicks on “webhook” channel subelement 1216, for example, using mouse pointer 1404 as shown in FIG. 14, pop-up menu 1406 may be displayed to the system administrator. The system administrator may further configure the “webhook” channel subelement 1216 by adding details in pop-up menu 1406.

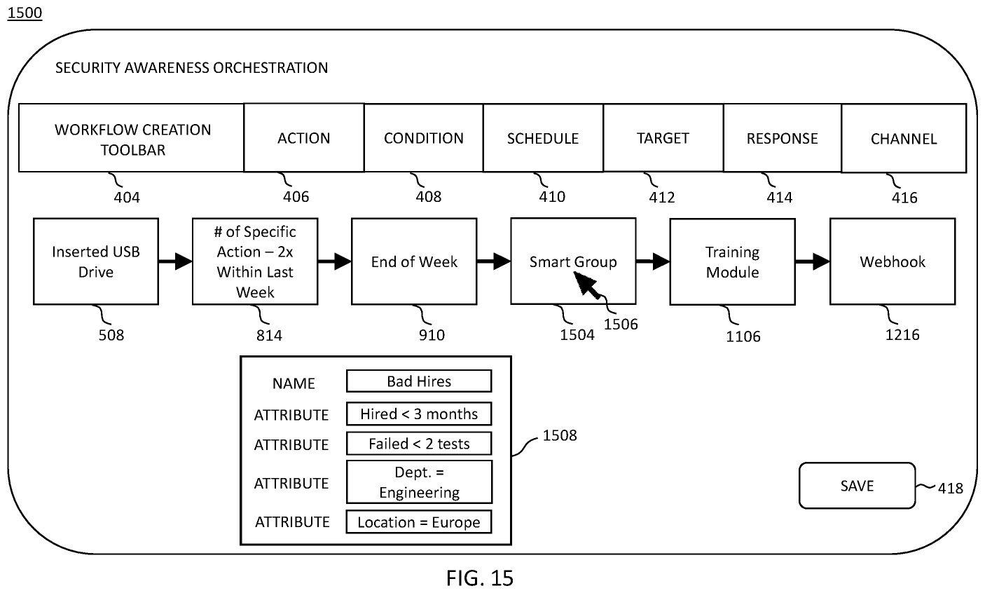

FIG. 15 illustrates example 1500 for further configuration of target subelement within a workflow designer workspace, according to some embodiments.

In the example of FIG. 15, a system administrator creates a workflow by connecting “inserted USB drive” action subelement 508, “#of specific action-within time period” condition subelement 814, “end of week” schedule subelement 910, “smart group” target subelement 1504, “training module” response subelement 1106, and “webhook” channel subelement 1216. In an example, the system administrator may create the workflow to be applied to a user who inserted a USB drive (action) 2 times within the last week (condition). The workflow is constructed such that training module (response) (the training module specific, for instance, to external drive usage training) is delivered to the smart group (target) via a webhook (channel).

In examples, if the system administrator clicks on “smart group” target subelement 1504, for example, using mouse pointer 1506 as shown in FIG. 15, pop-up menu 1508 may be displayed to the system administrator. The system administrator may further configure the “smart group” target subelement 1504 by adding details in pop-up menu 1508.

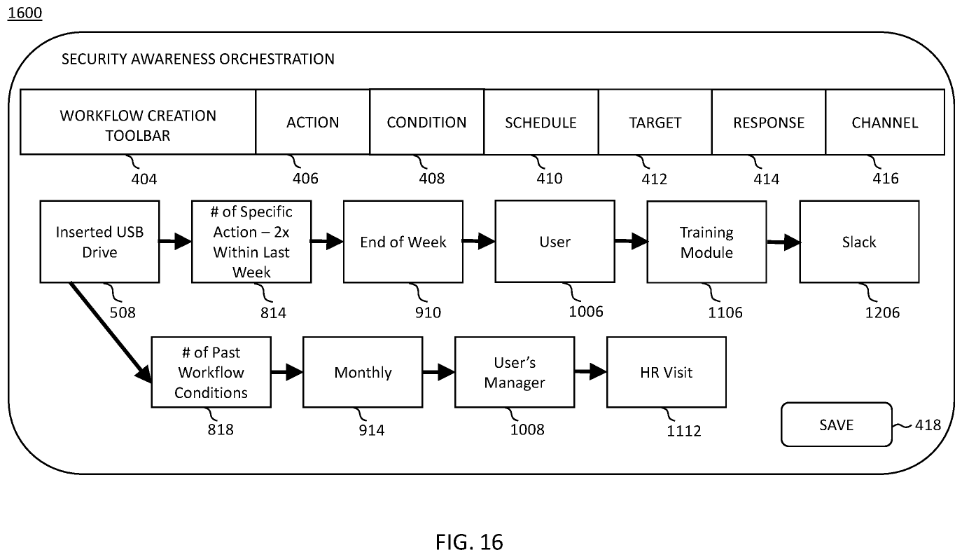

FIG. 16 illustrates example 1600 of multiple workflows within a single workflow designer workspace, according to some embodiments.

According to an implementation, within the workflow designer workspace, the system administrator designing the workflow may be able to create multiple workflows. FIG. 16 shows creation of two workflows with differentiated components that follow a single action. In an implementation, a system administrator may create a first workflow by connecting “inserted USB drive” action subelement 508, “#of specific action-within time period” condition subelement 814, “end of week” schedule subelement 910, “user” target subelement 1006, “training module” response subelement 1106, and “Slack” channel subelement 1206. According to an implementation, the system administrator may create a second workflow by connecting “inserted USB drive” action subelement 508, “#of past workflow conditions” condition subelement 818, “monthly” schedule subelement 914, “user's manager” target subelement 1008, and “HR visit” response subelement 1112.

In an implementation, details of the created or established workflows may be stored in workflow storage 244. In an example, information of configured elements and subelements of the workflows such as action, condition, schedule, response, target, and channel may be stored in workflow storage 244.

According to an implementation, security awareness and training platform 202 may maintain live counters such that any security event that passes through security awareness and training platform 202 and is applicable to an existing workflow (i.e., that meets the conditions established in a previously created workflow) may progress through the established workflow. According to an implementation, by allowing repeated use of a single workflow, the utility of any workflow that is created is maximized. According to some implementations, the live counters may also function to prevent users from progressing through the workflow only for as long as they do not fulfill a given condition related to the live counters. In an implementation, security awareness and training platform 202 may record the user/event data to progress the user through the workflow. In an example, when a live counter is updated, the workflow is completed, and the live counter may be zeroed.

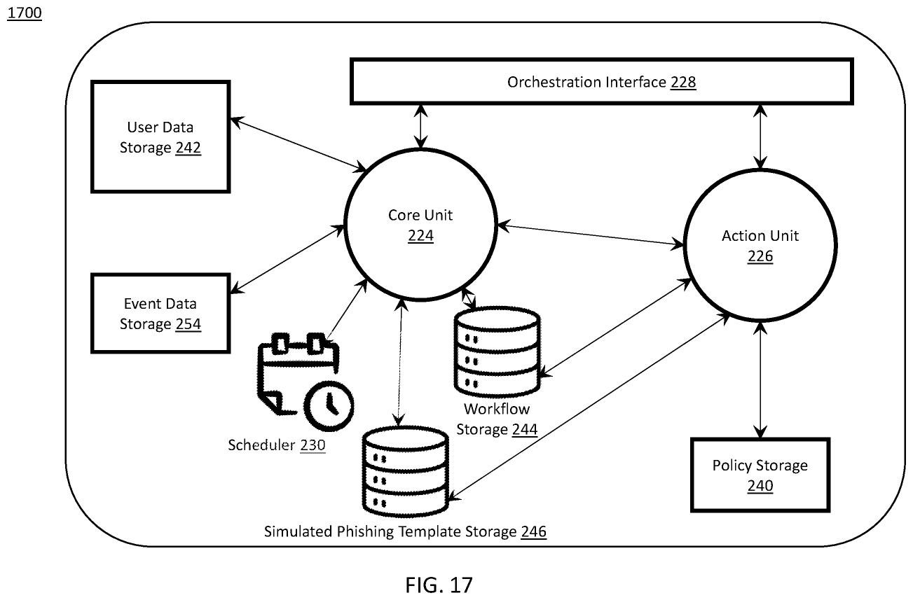

FIG. 17 depicts example 1700 of system architecture components and their relationships, according to some embodiments.

In the example of FIG. 17, core unit 224 is coupled with orchestration interface 228, scheduler 230, user data storage 242, workflow storage 244, simulated phishing template storage 246, event data storage 254, and action unit 226 for information exchange. Further, in the example of FIG. 17, action unit 226 is coupled with orchestration interface 228, workflow storage 244, simulated phishing template storage 246, policy storage 240, and core unit 224 for information exchange.

According to an implementation, core unit 224 may be configured to monitor event data of one or more users (which in examples may be stored in event data storage 254) to detect performance of an action associated with a security incident by one or more users. In an implementation, responsive to monitoring, core unit 224 may receive an indication that the action has been detected. In an implementation, action unit 226 may trigger one of execution or progression of a workflow. According to an implementation, responsive to the action, action unit 226 may communicate a response to the one or more users performing the action associated with the security incident.

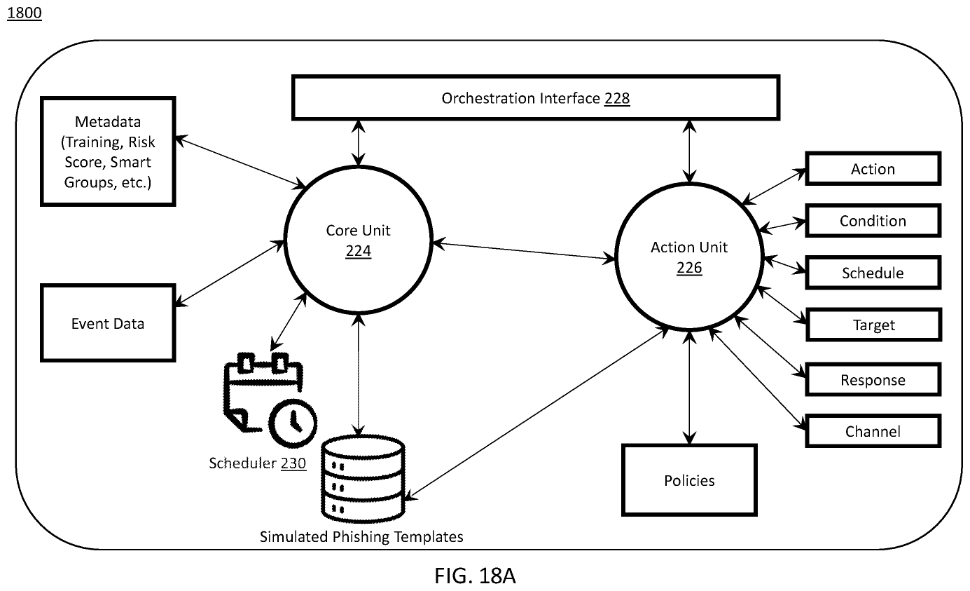

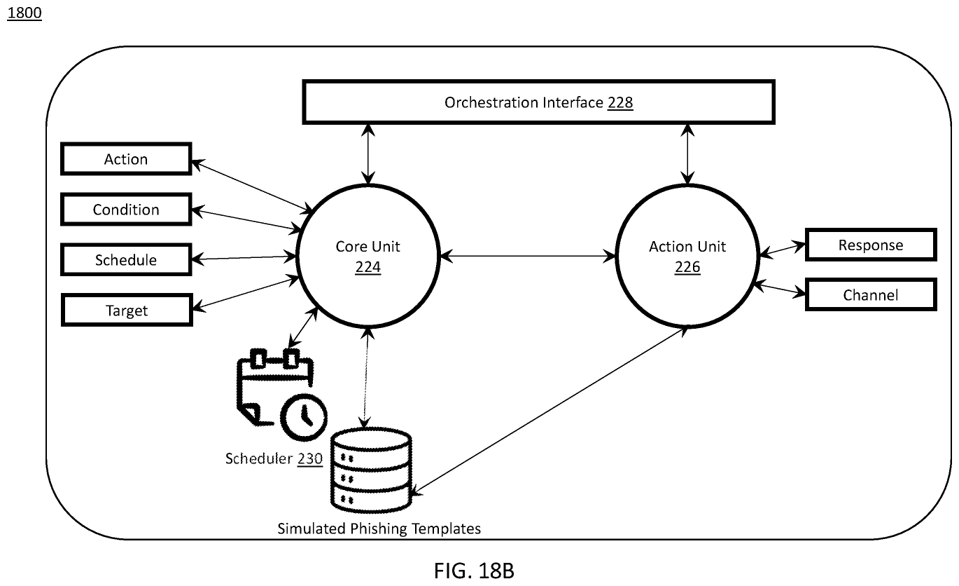

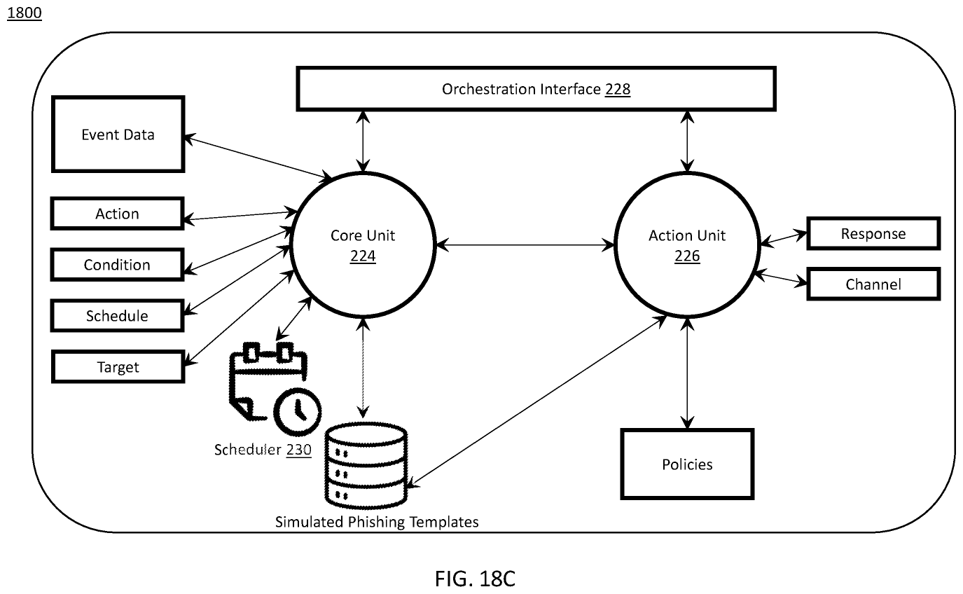

FIG. 18A, FIG. 18B, and FIG. 18C depict examples 1800 of information exchange between system architecture components, according to some embodiments.

Referring to FIG. 18A, core unit 224 may be configured to monitor the event data of one or more users to detect performance of an action associated with a security incident by a user. In an implementation, responsive to monitoring, core unit 224 may receive an indication that the action has been detected. According to an implementation, core unit 224 may extract metadata and other information related to the user who performed the action. Further, core unit 224 may exchange the information with action unit 226. According to an implementation, action unit 226 may trigger one of execution or progression of the workflow. In an example, action unit 226 may communicate a response (which is configured in the workflow) to a target through a channel.

Referring to FIG. 18B, detecting performance of an action associated with a security incident by a user, core unit 224 may be configured to extract information about configured elements, such as action, condition, schedule, and target. In an implementation, core unit 224 may exchange information about the user, and the action, condition, schedule, and target elements with action unit 226. According to an implementation, action unit 226 may trigger one of execution or progression of the workflow. In an example, action unit 226 may communicate a response to the target through a channel.

Referring to FIG. 18C, core unit 224 may be configured to monitor the event data of one or more users to detect performance of an action associated with a security incident by a user. In an implementation, responsive to monitoring, core unit 224 may receive an indication that the action has been detected. According to an implementation, core unit 224 may extract information about configured elements, such as action, condition, schedule, and target. In an implementation, core unit 224 may exchange information about the user, and the action, condition, schedule, and target elements with action unit 226. According to an implementation, action unit 226 may trigger one of execution or progression of the workflow. In an example, action unit 226 may communicate a response to the target through a channel.

According to an implementation, there may be control aspects and operational features that may be applied in the creation and execution of dynamic workflows. In examples, a limit may be set on a number of responses (such as exactly once, at most T times in a period, etc.) to avoid race conditions and repeated delivery of same training material. In an example, a race condition may be a condition where multiple workflows are triggered which may have similar results and that may, in an example, result in a same response to a same target occurring. The race condition may be a result of a logical error and may be difficult to predict. Therefore, methods to guard against the result of the race condition may be implemented. In some implementations, event processed flags may be used to indicate when a workflow is to move to the next step or to conclude, as well as to ensure that duplicate responses are not delivered for the same action or set of actions. Other control aspects and operational features that may be applied in the creation and execution of dynamic security orchestration workflows may include variable or configurable delay in response triggering, the ability to run workflows in “observation” mode to analyze workflows before implementation, the ability to clone a workflow from system templates, and the ability to define response escalations based on historical information (for example, user or target risk score(s), past incident type, frequency of execution of the workflow, etc.). In an example, a response escalation is a more severe or strong response that may be triggered by a workflow because of historical information that is relevant to the user performing the action, the action itself, or the past triggering history of the workflow itself. In an example, if a user that performs an action has historical information that is relevant, and has a low risk score, then the response that the workflow triggers when the user falls victim to a threat and performs an action may be more serious than if the workflow is triggered by a user with a high risk score.

In some implementations, various parts of the workflow may be decoupled. For example, actions and responses are decoupled such that they may be independently added, removed, or updated. In examples, minimum selections for functioning workflows may be required. In some examples, separate workflow configurations may be used for “execution” mode (i.e., scheduled vs. real-time, potentially with different service level agreements (SLA)). According to an aspect, security awareness and training platform 202 may support storage, execution, tracking and monitoring of workflows in compliance with the SLA.

In some implementations, live counters are maintained to be able to execute workflows quickly in real-time without having to mine older data. This allows workflow-match-trigger execution time to be minimized and helps meet SLA by determining workflow matches in real-time. Further, frequency counts may be maintained in counters which are reset when a workflow is triggered. An example is maintaining per-user-per-day counters of malware events, which in examples enables security awareness and training platform 202 to quickly check if a workflow with condition often malware events in the last two days matches the incoming event or not. In some implementations, independent workflow toolboxes may be run concurrently.

In an implementation, security awareness and training platform 202 guarantees “exactly once” delivery of responses, overcoming the challenge that external endpoint security vendors could send duplicate events (activity data). For example, if endpoint user data is being sent to the organization by multiple third parties or vendors of endpoint security systems, the workflow will only be triggered once for a user action even if the user is reported multiple times because of the multiple inputs, ensuring that the workflow is not triggered multiple times for the same user action.

According to an aspect, workflows may be graphically constructed with versatile elements which include actions (risky security behaviors of a user), conditions (related to the behavior or to the user), schedules (for administering responses), targets (users or groups of users to whom the workflows apply), responses (which are associated with targets), and channels (through which the responses are delivered). In an aspect, elements in a workflow may be configured to reflect the objectives of the workflow and the importance or relevance of interfaces and user endpoints. The responses of the workflows can interact with security policy systems so that the security policy systems may be updated to reflect outcomes of the workflows (using webhooks, for example, which enable the outcomes of the workflows to dynamically create or update security policies). In examples, the responses included in existing and new workflows may be configured to automatically reflect the security policy systems as they are updated. According to an implementation, using workflow elements and their configurations, workflows can be adapted according to multiple user factors and responses. Further, using historical conditions (such as the history of user responses relating to the same or other workflows), the workflows can be made dynamic, resulting in responses that change depending on historical outcomes.

According to an aspect of the present disclosure, the creation of orchestrated security awareness workflows through the method described allows an organization to deliver to their users (configured as targets) customized security awareness training that is specific to the user(s)′ involvement in security incidents and to a number of other parameters that are relevant to the incident. In turn, the organization can deliver effective security awareness training to their users and therefore can improve the security posture of the organization as a whole.

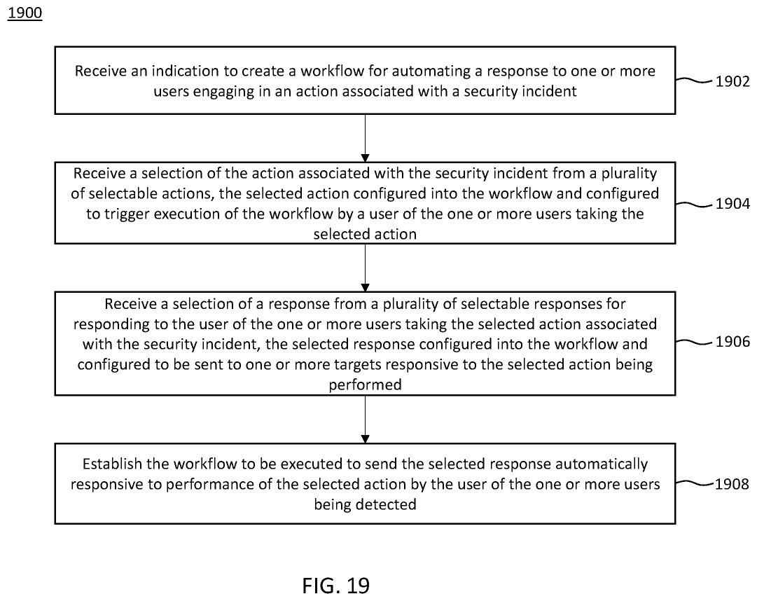

FIG. 19 depicts flowchart 1900 for establishing a workflow to be executed to send a response automatically responsive to a performance of an action by a user of one or more users being detected, according to some embodiments.

In a brief overview of an implementation of flowchart 1900, at step 1902, an indication to create a workflow for automating a response to one or more users engaging in an action associated with a security incident may be received. At step 1904, a selection of the action associated with the security incident from a plurality of selectable actions may be received. The selected action may be configured into the workflow and configured to trigger execution of the workflow by a user of the one or more users taking the selected action. At step 1906, a selection of a response from a plurality of selectable responses for responding to the user of the one or more users taking the selected action associated with the security incident may be received. The selected response may be configured into the workflow and configured to be sent to one or more targets responsive to the selected action being performed. At step 1908, the workflow to be executed to send the selected response automatically responsive to performance of the selected action by the user of the one or more users being detected may be established.

Step 1902 includes receiving an indication to create a workflow for automating a response to one or more users engaging in an action associated with a security incident. According to an implementation, orchestration interface 228 may receive the indication to create the workflow for automating the response to one or more users engaging in the action associated with the security incident.

Step 1904 includes receiving a selection of the action associated with the security incident from a plurality of selectable actions. The selected action may be configured into the workflow and configured to trigger execution of the workflow by a user of the one or more users taking the selected action. According to an implementation, orchestration interface 228 may receive the selection of the action associated with the security incident from the plurality of selectable actions. The selected action may be configured into the workflow and configured to trigger execution of the workflow by the user of the one or more users taking the selected action.

Step 1906 includes receiving a selection of a response from a plurality of selectable responses for responding to the user of the one or more users taking the selected action associated with the security incident. The selected response may be configured into the workflow and configured to be sent to one or more targets responsive to the selected action being performed. According to an implementation, orchestration interface 228 may receive the selection of the response from the plurality of selectable responses for responding to the user of the one or more users taking the selected action associated with the security incident. The selected response may be configured into the workflow and configured to be sent to one or more targets responsive to the selected action being performed.

Step 1908 includes establishing the workflow to be executed to send the selected response automatically responsive to performance of the selected action by the user of the one or more users being detected. According to an implementation, core unit 224 or action unit 226 may establish the workflow to be executed to send the selected response automatically responsive to performance of the selected action by the user of the one or more users being detected.

According to some implementations, orchestration interface 228 may receive a selection of one or more conditions from a plurality of selectable conditions for which to trigger one of execution of or progression through the workflow. The one or more selected conditions may be configured into the workflow. Further, in some embodiments, orchestration interface 228 may receive a selection of a schedule from a plurality of selectable schedules. The selected schedule may be configured into the workflow to cause the selected response to be sent by the workflow to the one or more targets according to the selected schedule. In some embodiments, orchestration interface 228 may receive an input of the one or more targets to configure into the workflow. The one or more targets may identify one or more users or groups of users to which the workflow sends the selected response. Also, in some embodiments, orchestration interface 228 may receive a selection of one or more channels from a plurality of selectable channels. The selected one or more channels may be configured into the workflow to cause the workflow to send the selected response to the one or more targets via the selected one or more channels.

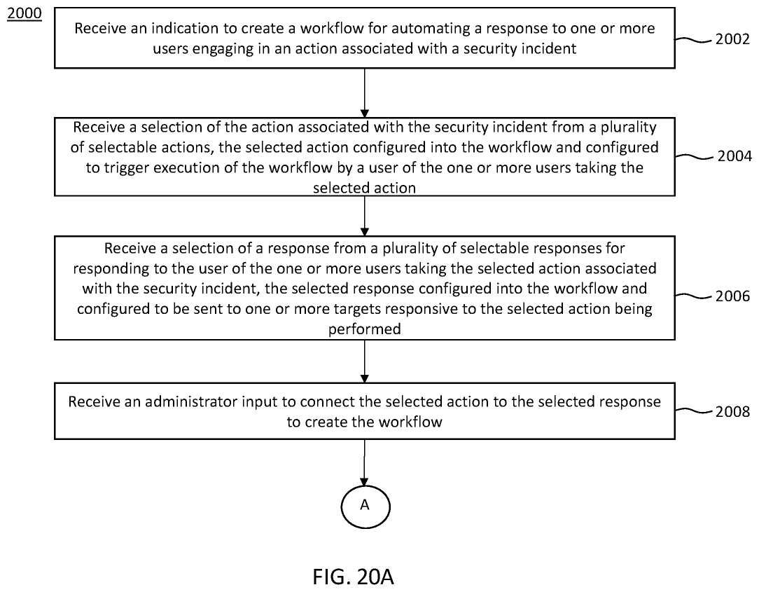

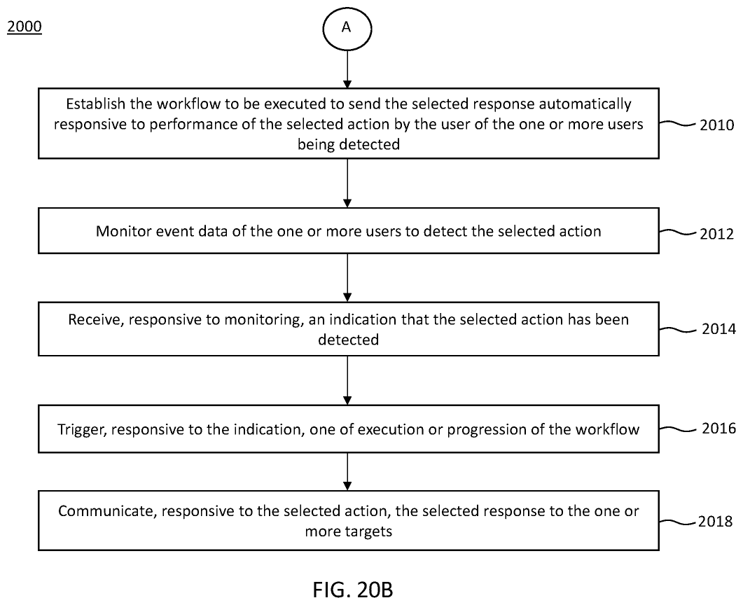

FIG. 20A and FIG. 20B depict flowchart 2000 for establishing a workflow to be executed to send a response automatically responsive to a performance of an action by a user and for communicating selected response to one or more targets, according to some embodiments.

In a brief overview of an implementation of flowchart 2000, at step 2002, an indication to create a workflow for automating a response to one or more users engaging in an action associated with a security incident may be received. At step 2004, a selection of the action associated with the security incident from a plurality of selectable actions may be received. The selected action may be configured into the workflow and configured to trigger execution of the workflow by a user of the one or more users taking the selected action. At step 2006, a selection of a response from a plurality of selectable responses for responding to the user of the one or more users taking the selected action associated with the security incident may be received. The selected response may be configured into the workflow and configured to be sent to one or more targets responsive to the selected action being performed. At step 2008, an administrator input to connect the selected action to the selected response to create the workflow may be received. At step 2010, the workflow to be executed to send the selected response automatically responsive to performance of the selected action by the user of the one or more users being detected may be established. At step 2012, event data of the one or more users may be monitored to detect the selected action. At step 2014, responsive to monitoring, an indication that the selected action has been detected may be received. At step 2016, responsive to indication, one of execution or progression of the workflow may be triggered. At step 2018, responsive to the selected action, the selected response may be communicated to the one or more targets.

Step 2002 includes receiving an indication to create a workflow for automating a response to one or more users engaging in an action associated with a security incident. According to an implementation, orchestration interface 228 may receive the indication to create the workflow for automating the response to one or more users engaging in the action associated with the security incident.

Step 2004 includes receiving a selection of the action associated with the security incident from a plurality of selectable actions. The selected action may be configured into the workflow and configured to trigger execution of the workflow by a user of the one or more users taking the selected action. According to an implementation, orchestration interface 228 may receive the selection of the action associated with the security incident from the plurality of selectable actions. The selected action may be configured into the workflow and configured to trigger execution of the workflow by the user of the one or more users taking the selected action.

Step 2006 includes receiving a selection of a response from a plurality of selectable responses for responding to the user of the one or more users taking the selected action associated with the security incident. The selected response may be configured into the workflow and configured to be sent to one or more targets responsive to the selected action being performed. According to an implementation, orchestration interface 228 may receive the selection of the response from the plurality of selectable responses for responding to the user of the one or more users taking the selected action associated with the security incident. The selected response may be configured into the workflow and configured to be sent to one or more targets responsive to the selected action being performed.

Step 2008 includes receiving an administrator input to connect the selected action to the selected response to create the workflow. According to an implementation, orchestration interface 228 may receive an administrator input (for example, an input from system administrator) to connect the selected action to the selected response to create the workflow.

Step 2010 includes establishing the workflow to be executed to send the selected response automatically responsive to performance of the selected action by the user of the one or more users being detected. According to an implementation, core unit 224 or action unit 226 may establish the workflow to be executed to send the selected response automatically responsive to performance of the selected action by the user of the one or more users being detected.

According to some implementations, orchestration interface 228 may receive a selection of one or more conditions from a plurality of selectable conditions for which to trigger one of execution of or progression through the workflow. The one or more selected conditions may be configured into the workflow. Further, in some embodiments, orchestration interface 228 may receive a selection of a schedule from a plurality of selectable schedules. The selected schedule may be configured into the workflow to cause the selected response to be sent by the workflow to the one or more targets according to the selected schedule. In some embodiments, orchestration interface 228 may receive an input of the one or more targets to configure into the workflow. The one or more targets may identify one or more users or groups of users to which the workflow sends the selected response. Also, in some embodiments, orchestration interface 228 may receive a selection of one or more channels from a plurality of selectable channels. The selected one or more channels may be configured into the workflow to cause the workflow to send the selected response to the one or more targets via the selected one or more channels.

Step 2012 includes monitoring event data of the one or more users to detect the selected action. According to an implementation, core unit 224 may be configured to monitor the event data of the one or more users to detect the selected action.

Step 2014 includes receiving, responsive to monitoring, an indication that the selected action has been detected. According to an implementation, action unit 226 may be configured to receive, responsive to monitoring, the indication that the selected action has been detected.

Step 2016 includes triggering, responsive to the indication, one of execution or progression of the workflow. In an implementation, action unit 226 may trigger, responsive to the indication, one of execution or progression of the workflow.

Step 2018 includes communicating, responsive to the selected action, the selected response to the one or more targets. In an implementation, action unit 226 may communicate, responsive to the selected action, the selected response to the one or more targets.

The systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMS, RAMS, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C #, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method comprising:
receiving, by an interface provided by one or more servers, an indication to create a workflow for automating a response to one or more users engaging in an action associated with a security incident;
receiving, by the interface, a selection of the action associated with the security incident from a plurality of selectable actions, the selected action configured into the workflow and configured to trigger execution of the workflow by a user of the one or more users taking the selected action;
receiving, by the interface, a selection of a response from a plurality of selectable responses for responding to the user of the one or more users taking the selected action associated with the security incident, the selected response configured into the workflow and configured to be sent to one or more targets responsive to the selected action being performed; and
establishing, by the one or more servers, the workflow to be executed to send the selected response automatically responsive to performance of the selected action by the user of the one or more users being detected.

2. The method of claim 1, further comprising receiving, by the interface, a selection of one or more conditions from a plurality of selectable conditions for which to trigger one of execution of or progression through the workflow, the one or more selected conditions configured into the workflow.

3. The method of claim 1, further comprising receiving, by the interface, a selection of a schedule from a plurality of selectable schedules, the selected schedule configured into the workflow to cause the selected response to be sent by the workflow to the one or more targets according to the selected schedule.

4. The method of claim 1, further comprising receiving, by the interface, an input of the one or more targets to configure into the workflow, the one or more targets identifying one or more users or groups of users to which the workflow sends the selected response.

5. The method of claim 1, further comprising receiving, by the interface, a selection of one or more channels from a plurality of selectable channels, the selected one or more channels configured into the workflow to cause the workflow to send the selected response to the one or more targets via the selected one or more channels.

6. The method of claim 1, further comprising receiving, by the interface, administrator input to connect the selected action to the selected response to create the workflow.

7. The method of claim 1, further comprising receiving, by the interface, administrator input to arrange the selected action and the selected response on a canvas provided by the interface.

8. The method of claim 1, further comprising monitoring, by the one or more servers, event data of the one or more users to detect the selected action.

9. The method of claim 8, further comprising receiving, by the one or more servers responsive to monitoring, an indication that the selected action has been detected and responsive to the indication, triggering one of execution or progression of the workflow.

10. The method of claim 9, further comprising communicating, by the one or more servers, responsive to the selected action, the selected response to the one or more targets.

11. A system comprising:
one or more servers configured to:
receive, by an interface provided by the one or more servers, an indication to create a workflow for automating a response to one or more users engaging in an action associated with a security incident;
receive, by the interface, a selection of the action associated with the security incident from a plurality of selectable actions, the selected action configured into the workflow and configured to trigger execution of the workflow by a user of the one or more users taking the selected action;
receive, by the interface, a selection of a response from a plurality of selectable responses for responding to the user of the one or more users taking the selected action associated with the security incident, the selected response configured into the workflow and configured to be sent to one or more targets responsive to the selected action being performed; and
establish the workflow to be executed to send the selected response automatically responsive to performance of the selected action by the user of the one or more users being detected.

12. The system of claim 11, wherein the interface is further configured to receive a selection of one or more conditions from a plurality of selectable conditions for which to trigger one of execution of or progression through the workflow, the one or more selected conditions configured into the workflow.

13. The system of claim 11, wherein the interface is further configured to receive a selection of a schedule from a plurality of selectable schedules, the selected schedule configured into the workflow to cause the selected response to be sent by the workflow to the one or more targets according to the selected schedule.

14. The system of claim 11, wherein the interface is further configured to receive an input of the one or more targets to configure into the workflow, the one or more targets identifying one or more users or groups of users to which the workflow sends the selected response.

15. The system of claim 11, wherein the user interface is further configured to receive, a selection of one or more channels from a plurality of selectable channels, the selected one or more channels configured into the workflow to cause the workflow to send the selected response to the one or more targets via the selected one or more channels.

16. The system of claim 11, wherein the interface is further configured to receive administrator input to connect the selected action to the selected response to create the workflow.

17. The system of claim 11, wherein the interface is further configured to receive administrator input to arrange the selected action and the selected response on a canvas provided by the interface.

18. The system of claim 11, wherein the one or more servers is further configured to monitor event data of the one or more users to detect the selected action.

19. The system of claim 18, wherein the one or more servers is further configured to receive, responsive to monitoring, an indication that the selected action has been detected and responsive to the indication, triggering one of execution or progression of the workflow.

20. The system of claim 19, wherein the one or more servers is further configured to communicate, responsive to the selected action, the selected response to the one or more targets.
